(19) United States
(12) Patent Application Publication
(10) Pub. No.: US 2017/0330343 A1
(43) Pub. Date: Nov. 16, 2017

(54) SIGHT LINE IDENTIFICATION APPARATUS AND SIGHT LINE IDENTIFICATION METHOD

(71) Applicant: FUJITSU LIMITED, Kawasaki-shi (JP)

(72) Inventors: Yoshihide Fujita, Kawasaki (JP); Akinori Taguchi, Kawasaki (JP); Motonobu Mihara, Kawasaki (JP)

(73) Assignee: FUJITSU LIMITED, Kawasaki-shi (JP)

(21) Appl. No.: 15/482,930

(22) Filed: Apr. 10, 2017

(30) Foreign Application Priority Data
May 10, 2016 (JP) 2016-094877

(51) Int. Cl. G06T 7/70; G06T 7/00

(52) U.S. Cl. CPC G06T 7/70; G06T 7/0004

(57) ABSTRACT

A sight line identification apparatus includes a sight line sensor configured to output a signal in accordance with a sight line, a memory configured to store positional information between a plurality of objects, and a processor coupled to the memory and configured to produce a sight line pattern including a position of the sight line or a direction of the sight line based on the output signal from the sight line sensor estimate each objects pointed to by the sight line and an order of the objects pointed to by the sight line, based on information including the positional information and the sight line pattern, and when there are a plurality of combinations of the estimated objects and the estimated order of the objects, select one of the plurality of combinations based on the positional information.

### CROSS-REFERENCE TO RELATED APPLICATION

This application is based upon and claims the benefit of priority of the prior Japanese Patent Application No. 2016-094877, filed on May 10, 2016, the entire contents of which are incorporated herein by reference.

### FIELD

The embodiments discussed herein relate to a sight line identification apparatus and a sight line identification method.

### BACKGROUND

Recently, in plants and factories, an increasing number of sight line detecting apparatuses have been introduced to reduce errors in inspection work in an inspection operation on a facility, and avoid an accident which may be caused by the error in the inspection work. The sight line detecting apparatus detects the sight line of an inspector at inspection and identifies an object (inspection item) at which the inspector is gazing, which allows determination of whether the inspection work is appropriately performed.

In one of the known techniques of supporting such inspection work, whether inspection work is appropriately performed is determined based on the similarity between a work image included in a procedure manual of inspection work and a visual field image of the inspector acquired during the inspection work (see Japanese Laid-open Patent Publication No. 2013-097466, for example).

In one of the known techniques of identifying an object at which the inspector is gazing, an object at which a user is gazing is identified based on a time difference between the time of detection of an event that induces the user to move the direction of the sight line and the time of occurrence of the event (refer to International Publication Pamphlet No. WO 2010/143377, for example).

### SUMMARY

According to an aspect of the invention, a sight line identification apparatus includes a sight line sensor configured to output a signal in accordance with a sight line, a memory configured to store positional information between a plurality of objects, and a processor coupled to the memory and configured to produce a sight line pattern including a position of the sight line or a direction of the sight line based on the output signal from the sight line sensor estimate each objects pointed to by the sight line and an order of the objects pointed to by the sight line, based on information including the positional information and the sight line pattern, and when there are a plurality of combinations of the estimated objects and the estimated order of the objects, select one of the plurality of combinations based on the positional information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a functional configuration of an inspection supporting apparatus according to a first embodiment;

FIG. 2 is a diagram illustrating a first example of an inspection item database;

FIG. 3 is a flowchart for description of processing performed by the inspection supporting apparatus according to the first embodiment;

FIG. 4 is a diagram for description of a sight line pattern producing method;

FIG. 5 is a diagram illustrating exemplary sight line pattern data;

FIG. 6 is a flowchart for description of the content of inspection item estimation processing according to the first embodiment;

FIG. 7A is a first flowchart for description of the content of processing of associating each stay point with an inspection item;

FIG. 7B is a second flowchart for description of the content the processing of associating each stay point with an inspection item;

FIG. 8A is a first diagram for description of a first example of the association of each stay point with an inspection item;

FIG. 8B is a second diagram for description of the first example of the association of each stay point with an inspection item;

FIG. 8C is a third diagram for description of the first example of the association of each stay point with an inspection item;

FIG. 9A is a first diagram for description of a second example of the association of each stay point with an inspection item;

FIG. 9B is a second diagram for description of the second example of the association of each stay point with an inspection item;

FIG. 9C is a third diagram for description of the second example of the association of each stay point with an inspection item;

FIG. 10A is a first diagram for description of a third example of the association of each stay point with an inspection item;

FIG. 10B is a second diagram for description of the third example of the association of each stay point with an inspection item;

FIG. 10C is a third diagram for description of the third example of the association of each stay point with an inspection item;

FIG. 11A is a first diagram for description of a fourth example of the association of each stay point with an inspection item;

FIG. 11B is a second diagram for description of the fourth example of the association of each stay point with an inspection item;

FIG. 11C is a third diagram for description of the fourth example of the association of each stay point with an inspection item;

FIG. 12A is a first flowchart for description of the content of inspection item identification processing according to the first embodiment;

FIG. 12B is a second flowchart for description of the content the inspection item identification processing according to the first embodiment;

FIG. 12C is a third flowchart for description of the content of the inspection item identification processing according to the first embodiment;

FIG. 13 is a diagram illustrating a second example of the inspection item database;

FIG. 14 is a diagram illustrating a third example of the inspection item database;

FIG. 15 is a diagram illustrating estimated patterns and weights in the second example of the association of each stay point with an inspection item;

FIG. 16 is a flowchart for description of part of inspection item identification processing according to a second embodiment;

FIG. 17A is a first flowchart for description of the content of inspection item estimation processing according to a third embodiment;

FIG. 17B is a second flowchart for description of the content the inspection item estimation processing according to the third embodiment;

FIG. 18A is a first diagram for description of a fifth example of the association of each stay point with an inspection item;

FIG. 18B is a second diagram for description of the fifth example of the association of each stay point with an inspection item;

FIG. 18C is a third diagram for description of the fifth example of the association of each stay point with an inspection item;

FIG. 19 is a flowchart for description of the content of inspection item identification processing according to a fourth embodiment;

FIG. 20A is a first diagram for description of a sixth example of the association of each stay point with an inspection item;

FIG. 20B is a second diagram for description of the sixth example of the association of each stay point with an inspection item;

FIG. 21 is a diagram for description of an inter-barycenter distance between a stay point and an inspection item;

FIG. 22 is a diagram illustrating an exemplary positional relation between stay points and inspection items;

FIG. 23 is a flowchart for description of a modification of the inspection item identification processing according to the fourth embodiment; and

FIG. 24 is a diagram illustrating a hardware configuration of a computer.

### DESCRIPTION OF EMBODIMENTS

For example, various inspection items of a facility to be inspected are displayed on a work image included in the above-described procedure manual. In some facilities to be inspected, for example, multiple objects having similar appearances are disposed, or objects are arranged in similar patterns at multiple places. Thus, in the calculation of the similarity between the work image included in the procedure manual and the visual field image of the inspector, it is difficult to identify which work image corresponds to the visual field image of the inspector or which region in the work image the visual field image corresponds to. In such a condition, it is difficult to determine whether inspection work has been appropriately performed.

In an aspect, the present embodiment is intended to identify an object to which the sight line of a person watching the object points from among multiple objects having similar appearances and arrangement patterns.

### First Embodiment

In the present embodiment, an inspection supporting apparatus configured to support inspection work on a facility at, for example, a factory is described as an exemplary sight line identification apparatus configured to identify an object to which the sight line of a person points. The inspection supporting apparatus is configured to identify, based on the sight line of a person (hereinafter referred to as an “inspector”) who performs inspection of the facility, which inspection items the inspector has inspected in what order among multiple inspection items (objects) provided to the facility.

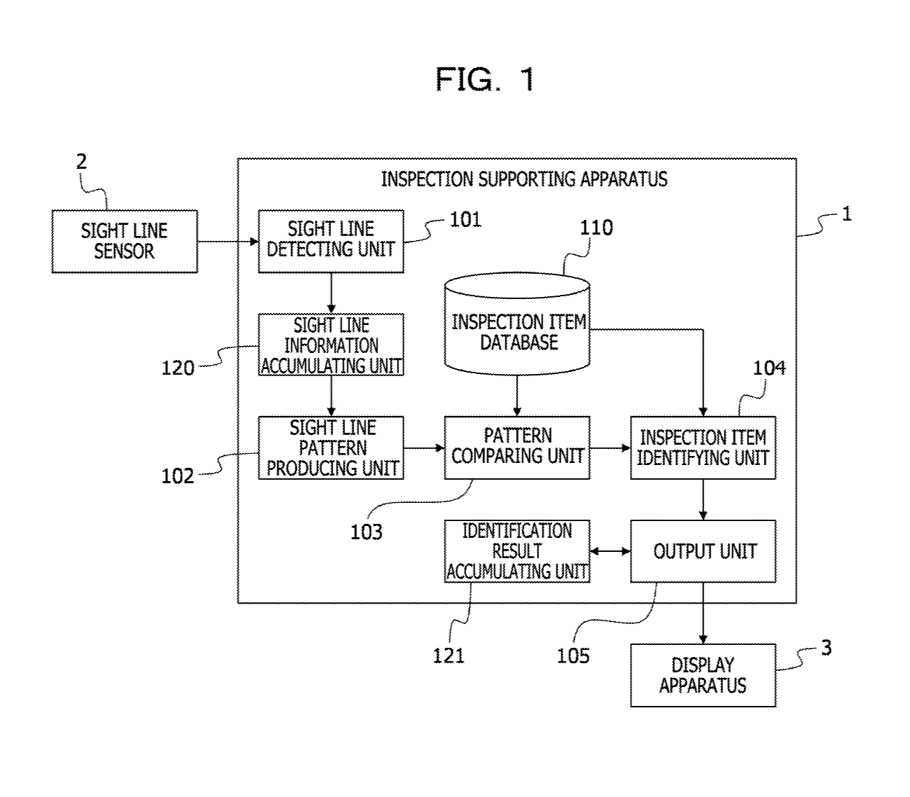

FIG. 1 is a diagram illustrating a functional configuration of an inspection supporting apparatus according to a first embodiment.

As illustrated in FIG. 1, this inspection supporting apparatus 1 according to the present embodiment includes a sight line detecting unit 101, a sight line pattern producing unit 102, a pattern comparing unit 103, an inspection item identifying unit 104, and an output unit 105. The inspection supporting apparatus 1 includes an inspection item database 110, a sight line information accumulating unit 120, and an identification result accumulating unit 121

The sight line detecting unit 101 detects the sight line of a person (inspector) based on an output signal from a sight line sensor 2 connected with the inspection supporting apparatus 1. The sight line detecting unit 101 detects the sight line of the inspector by, for example, a pupil-cornea reflection method. When the pupil-cornea reflection method is used by the sight line detecting unit 101 to detect a sight line, the sight line sensor 2 includes an infrared camera and a light source (for example, an infrared light-emitting diode (LED)) configured to emit infrared light. The infrared camera is installed toward a direction in which an eyeball (head) of the inspector inspecting a facility is included in an image capturing range. The infrared light-emitting diode is installed to emit infrared light in a direction toward the head of the inspector inspecting the facility is positioned. In other words, the infrared camera of the sight line sensor 2 captures an image of the head of the inspector irradiated with infrared light. The sight line detecting unit 101 extracts the position of cornea reflection and the position of a pupil from the image captured by the sight line sensor 2, and detects (calculates) the sight line of the inspector based on these positions.

The sight line detecting unit 101 repeatedly detects the sight line of the inspector at a predetermined time interval, and accumulates the detected sight line in the sight line information accumulating unit 120.

The sight line pattern producing unit 102 produces a sight line pattern of the inspector (in other words, a movement pattern of the sight line of the inspector) based on temporal data of the sight line of the inspector accumulated in the sight line information accumulating unit 120. The sight line pattern producing unit 102 produces, for example, a sight line pattern including a position at which the sight line has stayed moving, and a time for which the sight line has been stopping.

The pattern comparing unit 103 compares the sight line pattern produced by the sight line pattern producing unit 102 against an arrangement pattern of inspection items registered in the inspection item database 110, and estimates an inspection pattern including an item inspected by the inspector and the order of the inspection.

The inspection item identifying unit 104 identifies, based on information such as an inspection order and an importance degree registered in the inspection item database 110, a most appropriate inspection pattern from among the inspection patterns estimated by the pattern comparing unit 103. Hereinafter, an inspection pattern estimated by the pattern comparing unit 103 is also referred to as an “estimated pattern”.

The output unit 105 accumulates, in the identification result accumulating unit 121, for example, the identified inspection pattern or a result of the processing performed by the sight line detecting unit 101, the sight line pattern producing unit 102, the pattern comparing unit 103, and the inspection item identifying unit 104, and outputs the identified inspection pattern or the result of the processing to an external apparatus such as a display apparatus 3.

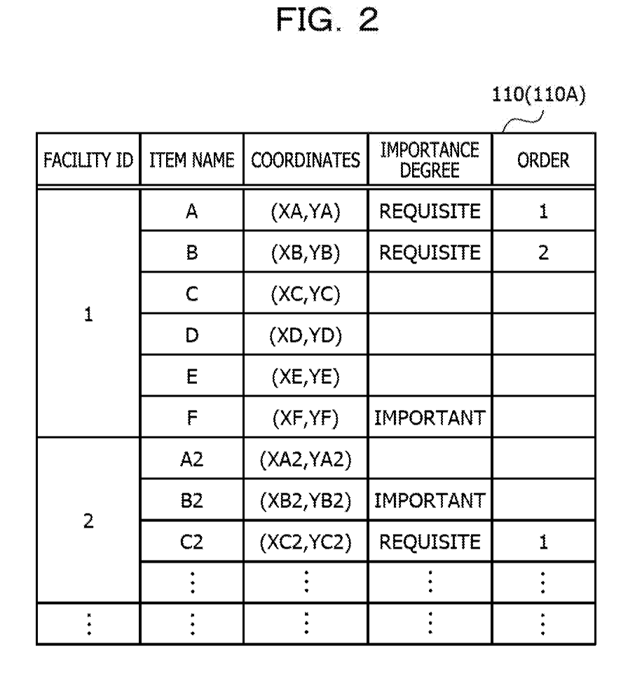

FIG. 2 is a diagram illustrating a first example of the inspection item database.

As illustrated in FIG. 2, the inspection item database 110 (110A) used in the present embodiment includes, for example, a facility ID, an item name, coordinates, an importance degree, and an order.

The facility ID is information identifying each of multiple facilities to be inspected. The facility ID is given, for example, a positive integer equal to one or larger. The item name is information indicating an inspection item of a facility identified by the facility ID. For example, in the inspection item database 110A illustrated in FIG. 2, a facility having a facility ID of “1” includes six inspection items having item names A to F.

The coordinates is information indicating the position of each inspection item (inspection point) in a space inspected by the inspector. In the inspection item database 110A illustrated in FIG. 2, multiple inspection items are disposed on one surface of an inspected facility, and the position of each inspection item in a plane on which the inspection items are disposed is expressed in two-dimensional coordinates.

The importance degree is information indicating the necessity to inspect each inspection item. For example, in the inspection item database 110A illustrated in FIG. 2, inspection items are categorized into an inspection item having an importance degree of “requisite”, an inspection item having an importance degree of “important”, and an inspection item having a blank importance degree. The inspection item having an importance degree of “requisite” is an inspection item to be inspected each time the facility is inspected. The inspection item having an importance degree of “important” is an inspection item not requisite but preferred to be inspected each time the facility is inspected. The inspection item having a blank importance degree is an inspection item that causes no problem, for example, when not inspected for a certain duration.

The order is information specifying an inspection order that is an order of items to be inspected in the facility. The order in the inspection item database 110 is not limited to information specifying the inspection order of all inspection items of a single facility, but may be information specifying only the inspection order of any predetermined inspection items among all the inspection items of the single facility. For example, the inspection item database 110A illustrated in FIG. 2 only specifies the inspection order of an inspection item having item name A and an inspection item having item name B among six inspection items of a facility having a facility ID of “1”. In the inspection item database 110A illustrated in FIG. 2, the inspection order for item name A is “1”, and the inspection order for item name B is “2”. In other words, the inspection item database 110A illustrated in FIG. 2 specifies that inspection of the facility having a facility ID of “1” is performed on the inspection item having item name A and then on the inspection item having item name B.

The inspection item database 110A illustrated in FIG. 2 is merely an example of the inspection item database 110 in the inspection supporting apparatus 1 according to the present embodiment. For example, only information on one facility may be registered in the inspection item database 110 according to the present embodiment. The inspection item database 110 according to the present embodiment may be a database including information different from the coordinates, the importance degrees, and the order of inspection items.

The inspection supporting apparatus 1 according to the present embodiment is an apparatus configured to support appropriate inspection of an inspected facility by an inspector. The inspection supporting apparatus 1 identifies and records any item inspected by the inspector and the order of the inspection based on the sight line of the inspector. The inspection supporting apparatus 1 and the sight line sensor 2 may be brought with the inspector to the inspection, or installed at the inspected facility. The sight line sensor 2 may be installed at each of multiple facilities and connected with the single inspection supporting apparatus 1 through a communication network.

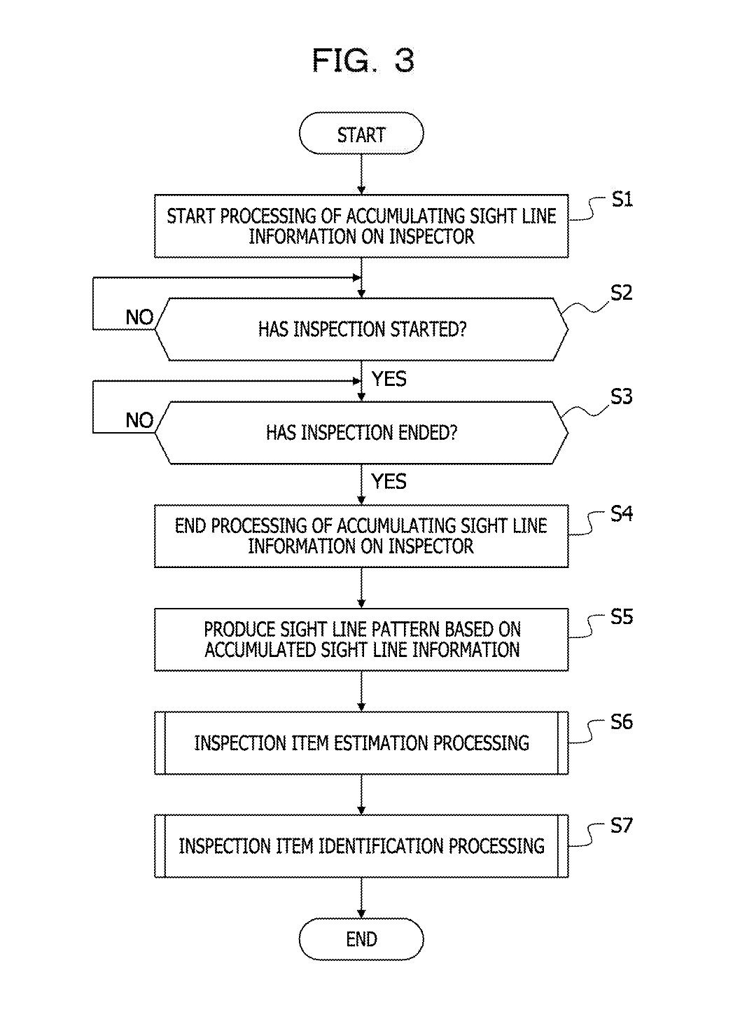

FIG. 3 is a flowchart for description of processing performed by the inspection supporting apparatus according to the first embodiment.

When started operating, as illustrated in FIG. 3, the inspection supporting apparatus 1 first starts processing of accumulating sight line information on an inspector (step S1). The processing of accumulating sight line information is performed by the sight line detecting unit 101. The sight line detecting unit 101 continues processing of acquiring an image from the sight line sensor 2 connected with the inspection supporting apparatus 1, and processing of detecting the sight line of the inspector from the acquired image and accumulating the sight line. The sight line detecting unit 101 detects (calculates) the sight line of the inspector by any known sight line detecting method. For example, the sight line detecting unit 101 acquires an image captured by the sight line sensor 2 including the infrared camera and the infrared LED and detects the sight line of the inspector by the pupil-cornea reflection method. The sight line detecting unit 101 accumulates information on the detected sight line and a time in the sight line information accumulating unit 120 as desired.

Subsequently, the inspection supporting apparatus 1 determines whether the inspector has started inspection (step S2).

If the inspector has not started inspection (NO at step S2), the inspection supporting apparatus 1 waits for the inspector to start inspection. Then, if the inspector has started inspection (YES at step S2), the inspection supporting apparatus 1 next determines whether the inspector has ended the inspection (step S3).

If the inspector has not ended the inspection (NO at step S3), the inspection supporting apparatus 1 waits for the inspector to end the inspection. Then, if the inspector has ended the inspection (YES at step S3), the inspection supporting apparatus 1 next ends the processing of accumulating sight line information (step S4).

The determination at step S2 is achieved based on, for example, whether the inspection supporting apparatus 1 has received information giving notification that the inspector has started inspection. The determination at step S3 is achieved based on, for example, whether the inspection supporting apparatus 1 has received information giving notification that the inspector has ended inspection.

The information giving notification that inspection has started, and the information giving notification that inspection has ended are input through, for example, operation on an input apparatus (not illustrated in FIG. 1) of the inspection supporting apparatus 1 by the inspector.

In a case in which the inspector brings the inspection supporting apparatus 1 with the inspector at inspection, the inspection supporting apparatus 1 may include, for example, a built-in acceleration sensor (not illustrated in FIG. 1) and determine, based on an output signal from this acceleration sensor, whether the inspector has started inspection and whether the inspector has ended inspection. When the acceleration sensor is used in the determination of whether inspection has started, the determination that the inspector has started inspection is achieved upon, for example, change of the state of the inspector, which is detected based on an output signal from the acceleration sensor, from a state indicating walking (moving) to a state indicating stopping. When the acceleration sensor is used in the determination of whether inspection has ended, the determination that the inspector has ended inspection is achieved upon, for example, change of the state of the inspector, which is detected based on an output signal from the acceleration sensor, from the state indicating stopping to the state indicating walking (moving).

When the inspection supporting apparatus 1 and the sight line sensor 2 are installed at an inspected facility, for example, a human detecting sensor (not illustrated in FIG. 1) may be used to determine, based on an output signal from the human detecting sensor, whether the inspector has started inspection and whether the inspector has ended inspection. When the human detecting sensor is used in the determination of whether inspection has started, the determination that the inspector has started inspection is achieved upon, for example, detection that a person has stayed at a predetermined position (position where the inspector stands at inspection) based on an output signal from the human detecting sensor. When the human detecting sensor is used in the determination of whether inspection has ended, the determination that the inspector has ended inspection is achieved upon, for example, detection that a person has moved from a predetermined position based on an output signal from the human detecting sensor.

Having ended the processing of accumulating sight line information (step S4), the inspection supporting apparatus 1 next produces a sight line pattern based on accumulated sight line information (step S5). The processing at step S5 is performed by the sight line pattern producing unit 102. The sight line pattern producing unit 102 reads temporal data of sight line information accumulated in the sight line information accumulating unit 120, and produces a sight line pattern including, for example, the position of each stay point of a sight line, a duration for which the slight line has stayed, and the order of the stay points.

Subsequently, the inspection supporting apparatus 1 performs inspection item estimation processing (step S6) of estimating any item inspected by the inspector based on the sight line pattern, and the arrangement pattern of inspection items registered in the inspection item database 110. The processing at step S6 is performed by the pattern comparing unit 103 by referring to the inspection item database 110. The pattern comparing unit 103 associates each stay point of the sight line pattern with an inspection item based on the sight line pattern and the arrangement pattern of inspection items of the inspected facility. If a result of the association of a stay point with an inspection item satisfies a predetermined condition, the pattern comparing unit 103 produces and holds an estimated pattern including an inspection item associated with a stay point, and the inspection order thereof. The predetermined condition is that, for example, all the stay points at each of which it is recognized that an inspection item (inspection point) has watched among stay points in the sight line pattern are associated with the inspection items. In the processing at step S6, the pattern comparing unit 103 outputs, to the inspection item identifying unit 104, for example, an estimation result (hereinafter also referred to as an “estimated pattern”) of an inspection pattern including a correspondence relation between a stay point and an inspection item.

Subsequently, the inspection supporting apparatus 1 performs inspection item identification processing (step S7) of identifying an item inspected by the inspector based on the estimated pattern obtained through the inspection item estimation processing, and an inspection order, an importance degree, and the like registered in the inspection item database 110. The processing at step S7 is performed by the inspection item identifying unit 104 by referring to the inspection item database 110.

When only one estimated pattern is obtained, the inspection item identifying unit 104 identifies an inspection item and an inspection order included in this estimated pattern to be an item inspected by the inspector and the order of the inspection, respectively. When two or more estimated patterns are obtained, the inspection item identifying unit 104 selects one estimated pattern based on, for example, the inspection order of inspection items in each estimated pattern, and the number of inspection items having high importance degrees. Then, the inspection item identifying unit 104 identifies an inspection item and an inspection order included in the selected estimated pattern to be an item inspected by the inspector and the order of the inspection, respectively.

The flowchart illustrated in FIG. 3 is merely an example of processing performed by the inspection supporting apparatus 1. In the processing performed by the inspection supporting apparatus 1 according to the present embodiment, for example, the order of steps S1 and S2 in FIG. 3 may be opposite. The processing at steps S5 to S7 performed by the inspection supporting apparatus 1 according to the present embodiment may be performed as appropriate, for example, while the inspector is inspecting the facility.

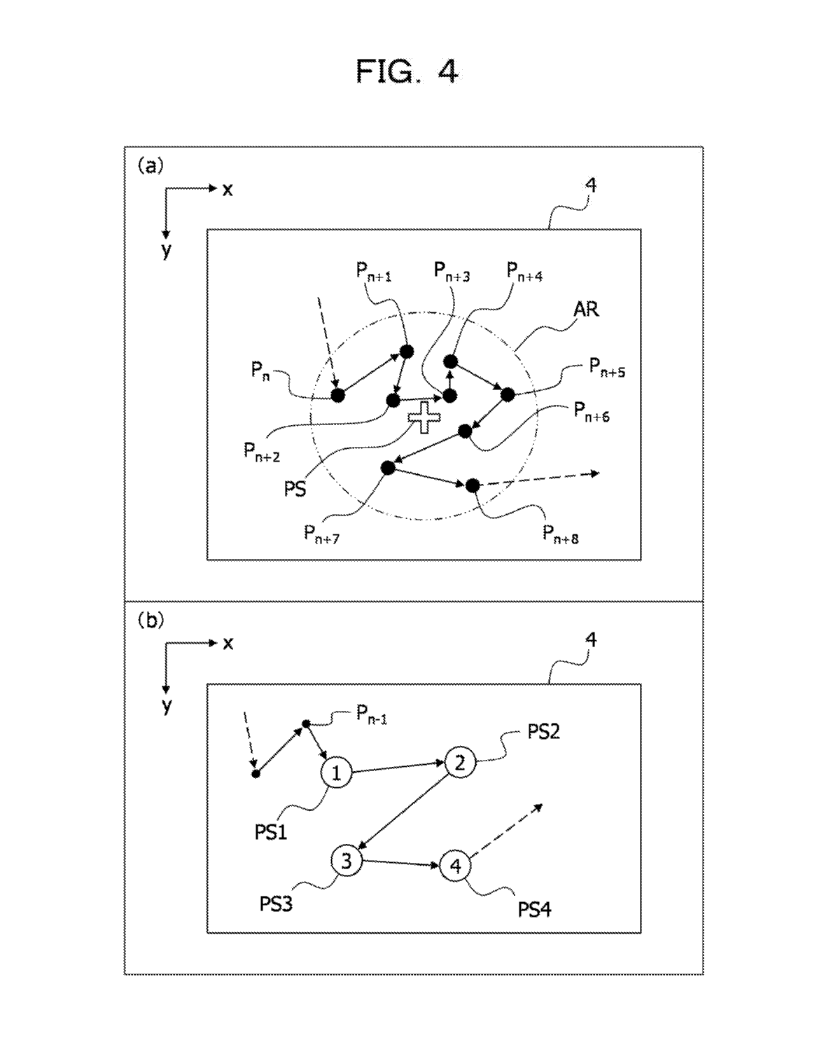

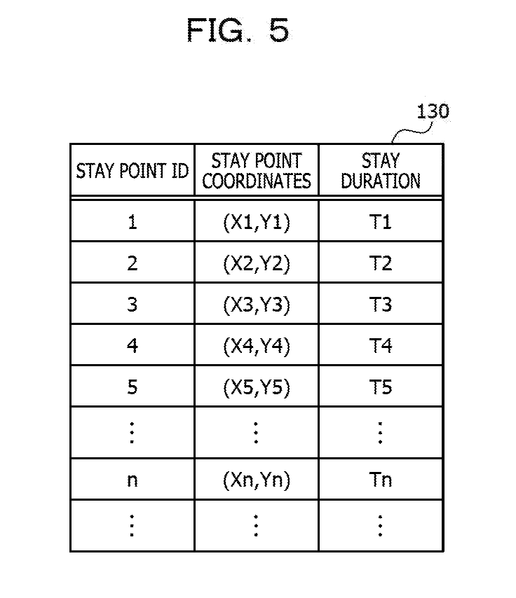

FIG. 4 is a diagram for description of a method of producing a sight line pattern. FIG. 5 is a diagram illustrating exemplary sight line pattern data.

The sight line pattern producing unit 102 detects a sight line pattern based on sight line information accumulated in the sight line information accumulating unit 120. The sight line information is information including the sight line of the inspector detected by the sight line detecting unit 101 for each image acquired from the sight line sensor 2 by a predetermined detection method.

The sight line pattern producing unit 102 determines temporal change of a position P of the sight line in a predetermined plane 4 based on the sight line information as illustrated in, for example, (a) of FIG. 4. In (a) of FIG. 4, indices n to n+8 of the position P of the sight line are each a numerical value indicating the order of the positions of the sight line in a temporal sequence. In other words, the position P of the sight line in the plane 4 illustrated in (a) of FIG. 4 moves in the order of Pₙ, Pₙ₊₁, Pₙ₊₂, Pₙ₊₃, Pₙ₊₄, Pₙ₊₅, Pₙ₊₆, Pₙ₊₇, and Pₙ₊₈.

When a predetermined number (for example, two) or more of sequential positions P of the sight line are included in a predetermined range AR, the sight line pattern producing unit 102 calculates the barycenter of these predetermined number or more of positions P of the sight line, and determines this barycenter to be a stay point PS of the sight line. The dimensions of the predetermined range AR, and the number of positions P of the sight line inside the predetermined range AR, at which it is recognized that the sight line stays, are set as appropriate based on, for example, the dimensions of an inspection item and an time interval at which the position P of the sight line is calculated.

When inspecting a facility, the inspector spends several seconds approximately to check, for example, a value of each inspection item. When the inspected facility includes multiple inspection items, the sight line pattern producing unit 102 detects multiple stay points PS1 to PS4 from sight line information as illustrated in (b) of FIG. 4. In (b) of FIG. 4, the center of each circle having a number inside indicates the position of a stay point, and the number inside the circle indicates the sequence number of the stay point in the detection. In other words, in the example illustrated in (b) of FIG. 4, the sight line of the inspector moves from a position Pn−1 to the vicinity of a first stay point PS1 and stays. Subsequently, the sight line of the inspector moves to the right from the vicinity of the first stay point PS1 and stays at the vicinity of a second stay point PS2, and then moves downward to the left from the vicinity of the second stay point PS2 and stays at the vicinity of a third stay point PS3. Subsequently, the sight line of the inspector moves to the right from the vicinity of the third stay point PS3 and stays at the vicinity of a fourth stay point PS4. Thereafter, for example, the sight line of the inspector moves upward to the right from the vicinity of the fourth stay point PS4.

Upon detection of each stay point from sight line information, the sight line pattern producing unit 102 provides a stay point ID to the detected stay point, and registers the stay point in data 130 of a sight line pattern as illustrated in, for example, FIG. 5, in association with the stay point ID, the coordinates of the stay point, and a stay duration. The stay point ID is, for example, a positive integer equal to one or larger, and the value of the stay point ID is increased by one at each detection of each stay point. The coordinates of the stay point is the coordinates of a barycenter calculated from the coordinates of multiple sequential positions P of the sight line in the predetermined range AR. The stay duration is a duration for which the sight line stays at one stay point, and is, for example, the product of the number of sequential positions P of the sight line in the predetermined range AR and the time interval of calculation of the position P of the sight line.

In this data 130 of the sight line pattern, the coordinates of a stay point indicates the position of the stay point in the predetermined plane 4, and the stay point ID indicates a movement sequential number of the stay point. The plane 4 on which the sight line pattern is produced is an optional plane set in the direction of the sight line of the inspector, and an xy coordinate system representing the plane 4 may be different from a coordinate system (for example, a world coordinate system) of the coordinates of an inspection item in the inspection item database 110A.

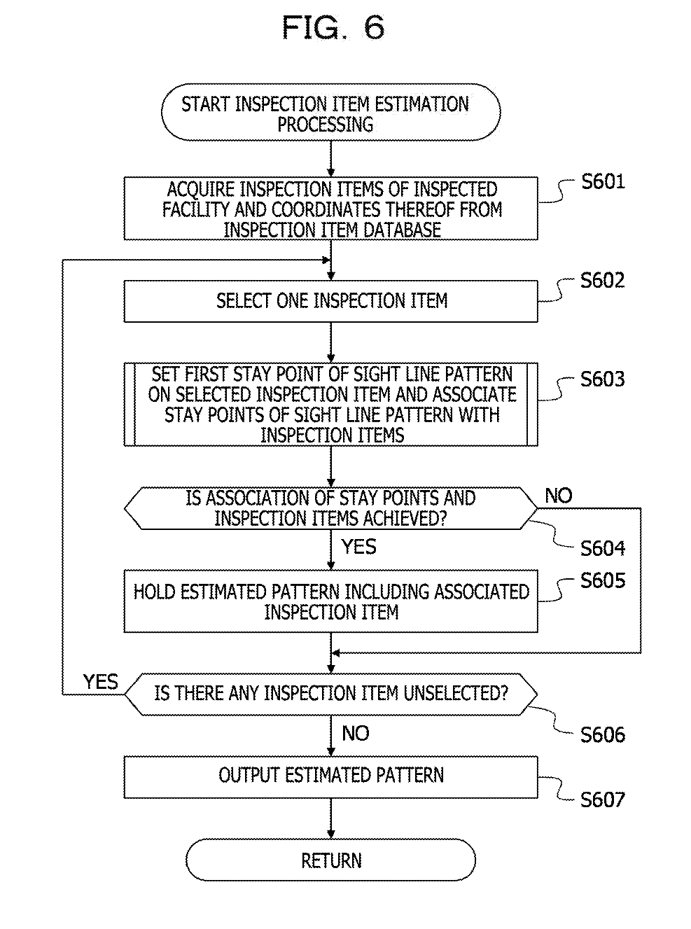

Having produced the data 130 of the sight line pattern at step S5, the inspection supporting apparatus 1 next performs the inspection item estimation processing (step S6). The inspection item estimation processing is performed by the pattern comparing unit 103. The pattern comparing unit 103 of the inspection supporting apparatus 1 according to the present embodiment performs, for example, processing illustrated in FIG. 6 as the inspection item estimation processing.

FIG. 6 is a flowchart for description of the content of the inspection item estimation processing according to the first embodiment.

When having started the inspection item estimation processing, the pattern comparing unit 103 first acquires inspection items of an inspected facility and the coordinates thereof from the inspection item database 110 as illustrated in FIG. 6 (step S601). At step S601, the pattern comparing unit 103 uses, for example, a facility ID input to the inspection supporting apparatus 1 at start of inspection as key information to read and acquire inspection items associated with the facility ID and the coordinates thereof from the inspection item database 110. When the inspection supporting apparatus 1 is provided to each inspected facility and only inspection item of one facility and the coordinates thereof are registered in the inspection item database 110, the pattern comparing unit 103 reads the registered inspection items and the coordinates thereof.

Subsequently, the pattern comparing unit 103 selects one of the read inspection items (step S602). At step S602, the pattern comparing unit 103 selects one inspection item according to a predetermined selection rule. According to the selection rule, for example, an inspection item having the highest importance degree and being the first in the order in the inspection item database 110 is selected from among inspection items not selected at step S602.

Subsequently, the pattern comparing unit 103 sets the first stay point of the sight line pattern on the selected inspection item, performs processing (step S603) of associating the stay points of the sight line pattern and the inspection items, and determines whether the association of the stay points and the inspection items with each other is achieved (step S604).

At step S603, the pattern comparing unit 103 translates each stay point so that, for example, the coordinates of the first stay point of the sight line pattern match with the coordinates of the selected inspection item. Thereafter, the pattern comparing unit 103 determines, for each stay point, whether an inspection item is included in a predetermined range, and associates any inspection item in the predetermined range with the stay point. Then, if the inspection items are associated with all the stay points at which the inspector is recognized as having watched the inspection items, the pattern comparing unit 103 determines that the association of the stay point and the inspection item with each other is achieved (YES at step S604).

If the association of the stay points and the inspection items with each other is achieved (YES at step S604), the pattern comparing unit 103 holds an estimated pattern including the inspection items and the associated stay point (step S605). Thereafter, the pattern comparing unit 103 determines whether there is any inspection item not yet selected at step S602 (step S606). If the association of the stay points and the inspection items with each other is not achieved (NO at step S604), the pattern comparing unit 103 skips the processing at step S605 and performs the determination at step S606.

If there is any inspection item not yet selected (YES at step S606), the pattern comparing unit 103 repeats the processing at step S602 and later. If all the inspection items are selected at step S602 (NO at step S606), the pattern comparing unit 103 outputs the estimated pattern to the inspection item identifying unit 104 (step S607), and ends the inspection item estimation processing (return).

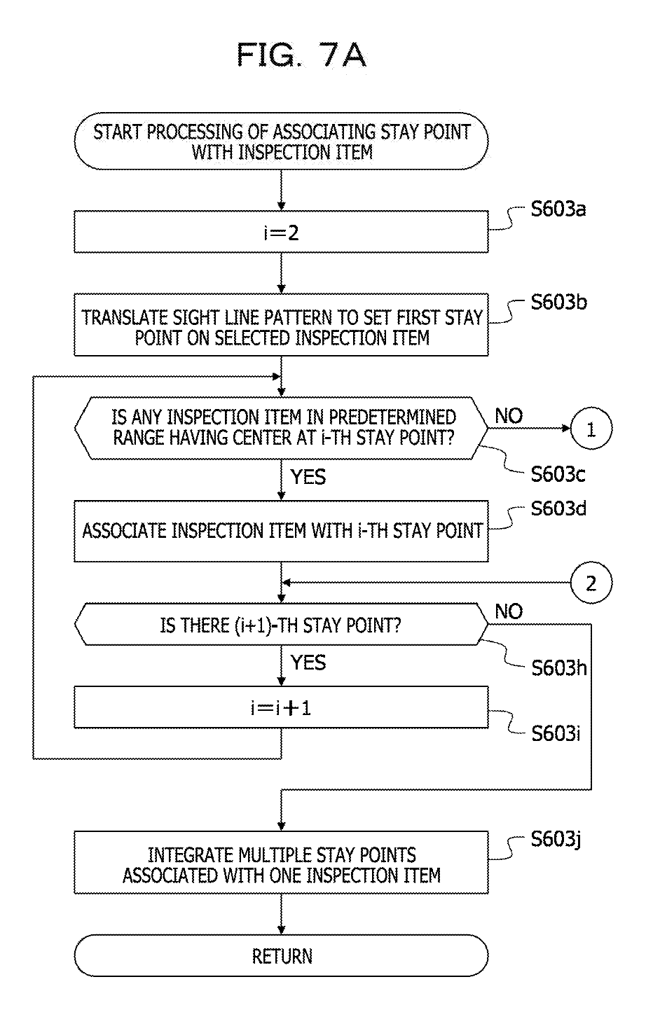

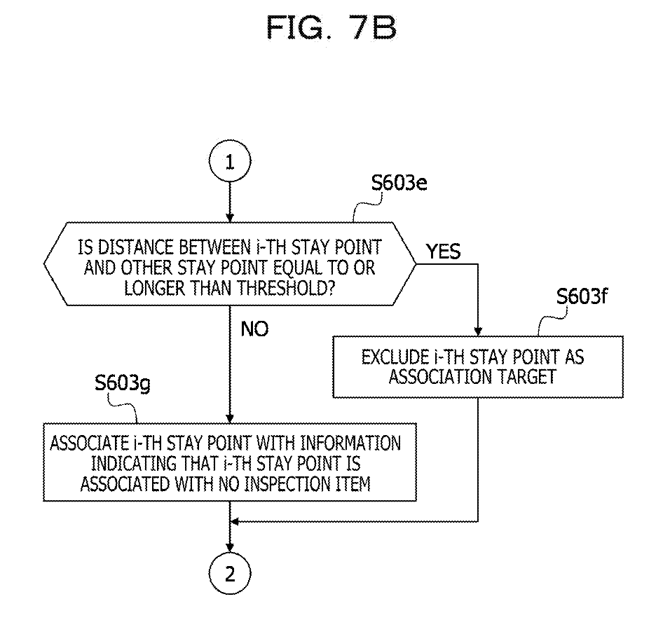

FIG. 7A is a first flowchart for description of the content of the processing of associating a stay point and an inspection item with each other. FIG. 7B is a second flowchart for description of the content of the processing of associating a stay point and an inspection item with each other.

In the processing of associating a stay point and an inspection item with each other (step S603), the pattern comparing unit 103 first sets i=2 as illustrated in FIG. 7A, where this variable i indicates the movement sequential number of a stay point (step S603a).

Subsequently, the pattern comparing unit 103 sets the first stay point of the sight line pattern on the selected inspection item in a plane including an arrangement pattern of inspection items (step S603b). If a coordinate system indicating the position of a stay point of the sight line pattern is different from a coordinate system indicating the coordinates of an inspection item, the pattern comparing unit 103 converts the coordinates indicating the position of a stay point based on a correspondence relation between the coordinate systems before placing the first stay point and the selected inspection item over one another.

Subsequently, the pattern comparing unit 103 determines whether any inspection item is included in a predetermined range having a center at the i-th stay point (step S603c). The predetermined range used in the determination at step S603c is set to, based on, for example, the dimensions of an inspection item, a range in which it is recognized that the sight line for the i-th stay point points to an inspection item.

If any inspection item is included in the predetermined range having a center at the i-th stay point (YES at step S603c), the pattern comparing unit 103 associates the inspection item with the i-th stay point (step S603d). Thereafter, the pattern comparing unit 103 determines whether there is the (i+1)-th stay point (step S603h). If no inspection item is included in the predetermined range having a center at the i-th stay point (NO at step S603c), the pattern comparing unit 103 performs the processing at steps S603e to S603g illustrated in FIG. 7B.

If no inspection item is included in the predetermined range having a center at the i-th stay point, the pattern comparing unit 103 next determines whether the distance between the i-th stay point and the other stay points is equal to or larger than a threshold (step S603e). The threshold used in the determination at step S603e is set to, based on, for example, the dimensions of an inspection item and an arrangement interval, such a value that the inspector can be recognized as watching a place other than the inspection items during inspection.

If the distance is equal to or larger than the threshold (YES at step S603e), the pattern comparing unit 103 excludes the i-th stay point as an association target (step S603f). In other words, if the i-th stay point is distant from the other stay points, the pattern comparing unit 103 determines that the sight line for the i-th stay point points to a place different from the inspection items, and temporarily deletes the i-th stay point from the sight line pattern. If the distance is smaller than the threshold (NO at step S603e), the pattern comparing unit 103 associates the i-th stay point with information indicating that no inspection item is to be associated (step S603g). Having completed the processing at steps S603e to S603g, the pattern comparing unit 103 next determines whether there is the (i+1)-th stay point as illustrated in FIG. 7A (step S603h).

If there is the (i+1)-th stay point (YES at step S603h), the pattern comparing unit 103 updates the variable i with i+1 (step S603i), and repeats the processing at step S603c and later. Then, if there is no (i+1)-th stay point (NO at step S603h), the pattern comparing unit 103 next integrates multiple stay points associated with an identical inspection item (step S603j). Having completed the processing at step S603j, the pattern comparing unit 103 ends the processing of associating a stay point and an inspection item with each other (return).

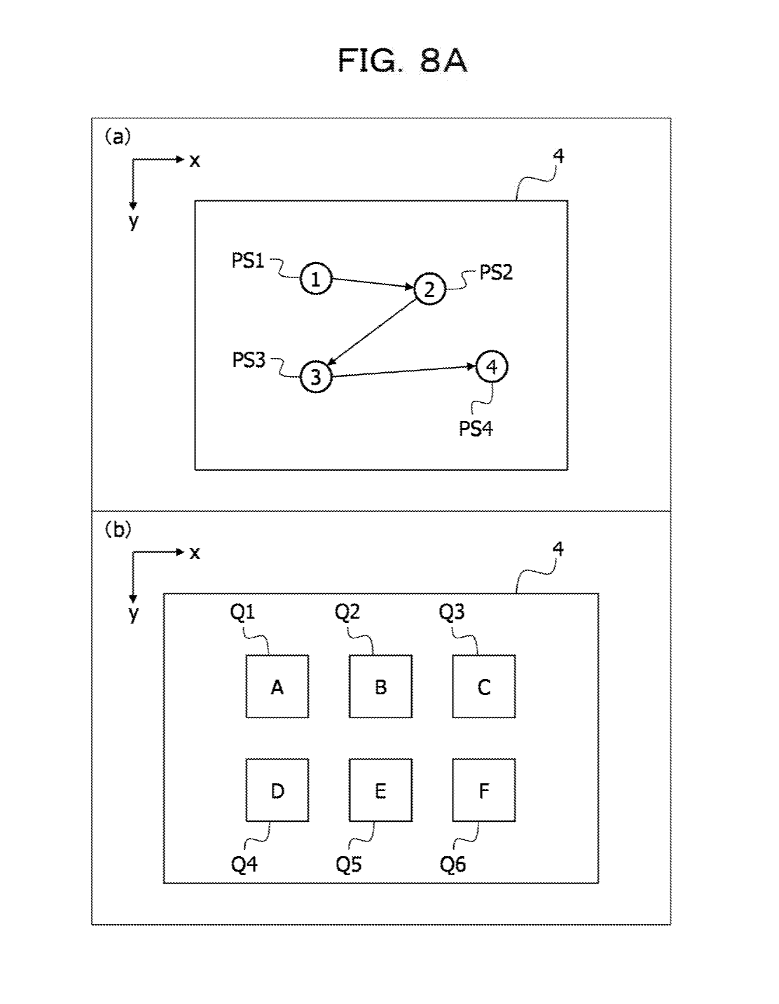

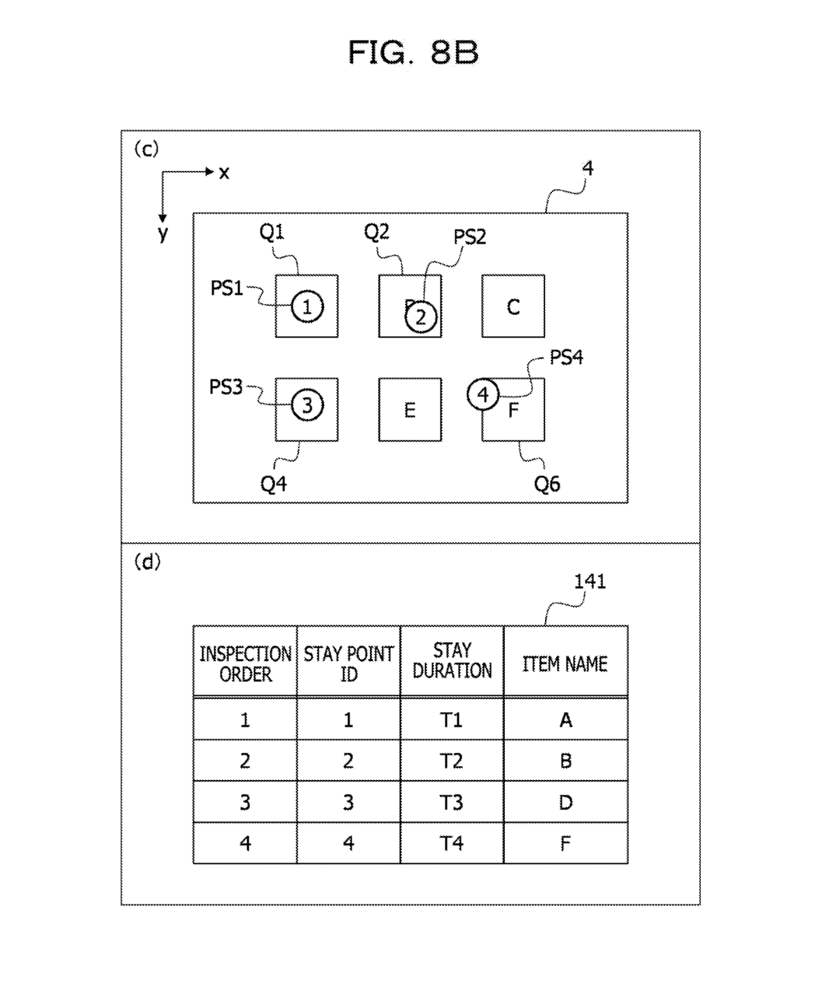

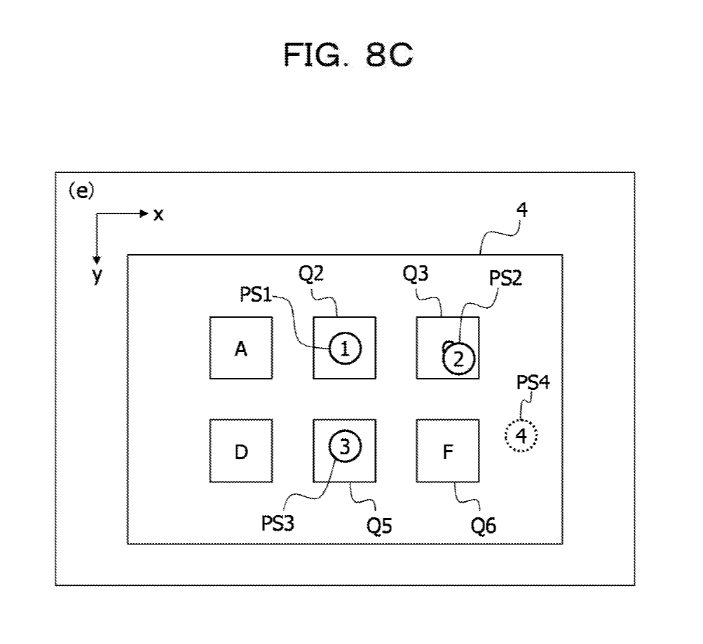

FIG. 8A is a first diagram for description of a first example of the association of each stay point with an inspection item. FIG. 8B is a second diagram for description of the first example of the association of each stay point with an inspection item. FIG. 8C is a third diagram for description of the first example of the association of each stay point with an inspection item.

The diagram (a) of FIG. 8A illustrates a sight line pattern in the plane 4 of the xy coordinate system, in other words, the positions of the stay points PS1 to PS4 and the movement sequential number thereof. In the sight line pattern illustrated in (a) of FIG. 8A, the sight line of the inspector stays at the first stay point PS1, which is the first stay point after inspection start, and then moves to the right and stays at the second stay point PS2. After staying at the second stay point PS2, the sight line of the inspector moves downward to the left, and stays at the third stay point PS3 at a position substantially identical to that of the first stay point PS1 in the horizontal direction (x direction). Thereafter, the sight line of the inspector moves to the right from the third stay point PS3, and stays at the fourth stay point PS4 to the right of the second stay point PS2 in the horizontal direction.

The diagram (b) of FIG. 8A illustrates an arrangement pattern of inspection items Q1 to Q6 of an inspected facility in the plane 4 of the xy coordinate system. In the arrangement pattern illustrated in (b) of FIG. 8A, the six inspection items Q1 to Q6 are arranged in a 2×3 matrix. The three inspection items Q1 to Q3 in the top row have item names of item name A, item name B, and item name C in this order from the left. The three inspection items Q4 to Q6 in the bottom row have item names of item name D, item name E, and item name F in this order from the left. In the following description, when distinguished, the inspection items Q1 to Q6 are referred to as the first inspection item Q1, the second inspection item Q2, the third inspection item Q3, the fourth inspection item Q4, the fifth inspection item Q5, and the sixth inspection item Q6 respectively.

In the inspection item estimation processing according to the present embodiment, one inspection item is selected (step S602), and the first stay point (the first stay point PS1) of the sight line pattern is set on the selected inspection item to perform the association of each stay point with an inspection item (step S603). If the first inspection item Q1 is selected at step S602, the pattern comparing unit 103 sets the first stay point PS1 on the first inspection item Q1 as illustrated in (c) of FIG. 8B to associate the second stay point PS2 to the fourth stay point PS4 with inspection items.

The second stay point PS2 and the second inspection item Q2 overlap with each other. Thus, when the sight line for the first stay point PS1 points to the first inspection item Q1, it is recognized that the sight line for the second stay point points to the second inspection item Q2.

The third stay point PS3 and the fourth inspection item Q4 overlap with each other. Thus, when the sight line for the first stay point PS1 points to the first inspection item Q1, it is recognized that the sight line for the third stay point PS3 points to the fourth inspection item Q4.

The fourth stay point PS4 has a center (barycenter) near the outer periphery of the sixth inspection item Q6. Thus, when the sight line for the first stay point PS1 points to the first inspection item Q1, it is recognized that the sight line for the fourth stay point PS4 points to the sixth inspection item Q6.

In other words, when the first stay point PS1 and the first inspection item Q1 are placed over one another, inspection items are associated with all stay points at which it is recognized that the inspector has watched the inspection items PS1 to PS4. Thus, the pattern comparing unit 103 determines that the association of each stay point with an inspection item is achieved at step S604 (YES at step S604). Accordingly, the pattern comparing unit 103 produces and holds an estimated pattern 141 illustrated in (d) of FIG. 8B (step S605). In the present embodiment, when the estimated pattern 141 is produced, an inspection order is associated with a stay point, an inspection item, and an stay duration. As described above, the stay duration is a duration for which the sight line stays at one stay point, and is registered in, for example, a sight line pattern 130 illustrated in FIG. 5.

The following describes the association of each stay point with an inspection item when the second inspection item Q2 is selected at step S602. In this case, the pattern comparing unit 103 sets the first stay point PS1 on the second inspection item Q2 as illustrated in (e) of FIG. 8C to associate the second stay point PS2 to the fourth stay point PS4 with inspection items.

The second stay point PS2 and the third inspection item Q3 overlap with each other. Thus, when the sight line for the first stay point PS1 points to the second inspection item Q2, it is recognized that the sight line for the second stay point PS2 points to the third inspection item Q3. The third stay point PS3 and the fifth inspection item Q5 overlap with each other. Thus, when the sight line for the first stay point PS1 points to the first inspection item Q1, it is recognized that the sight line for the third stay point PS3 points to the fifth inspection item Q5.

However, the fourth stay point PS4 does not overlap with any of the six inspection items Q1 to Q6. Thus, when associating the fourth stay point PS4 with an inspection item, the pattern comparing unit 103 performs the processing at steps S603e to S603g illustrated in FIG. 7B. As illustrated in (c) of FIG. 8B, the fourth stay point PS4 is not distant from the other stay points PS1 to PS3, and thus it is recognized that the sight line for the fourth stay point PS4 points to any one of the inspection items Q1 to Q6. Thus, the pattern comparing unit 103 does not exclude the fourth stay point PS4, but associates the fourth stay point PS4 with information indicating no inspection item to be associated (step S603g). Accordingly, when the first stay point PS1 is set on the second inspection item Q2, the pattern comparing unit 103 determines that the association of each stay point with an inspection item is not achieved at step S604 (NO at step S604).

When the first stay point PS1 is set on each of the third inspection item Q3 to the sixth inspection item Q6, too, the pattern comparing unit 103 determines that the association of each stay point with an inspection item is not achieved at step S604 (NO at step S604).

Consequently, in the inspection item estimation processing based on the sight line pattern illustrated in (a) of FIG. 8A and the arrangement pattern of inspection items illustrated in (b) of FIG. 8A, the one estimated pattern 141 illustrated in (d) of FIG. 8B is produced and output to the inspection item identifying unit 104.

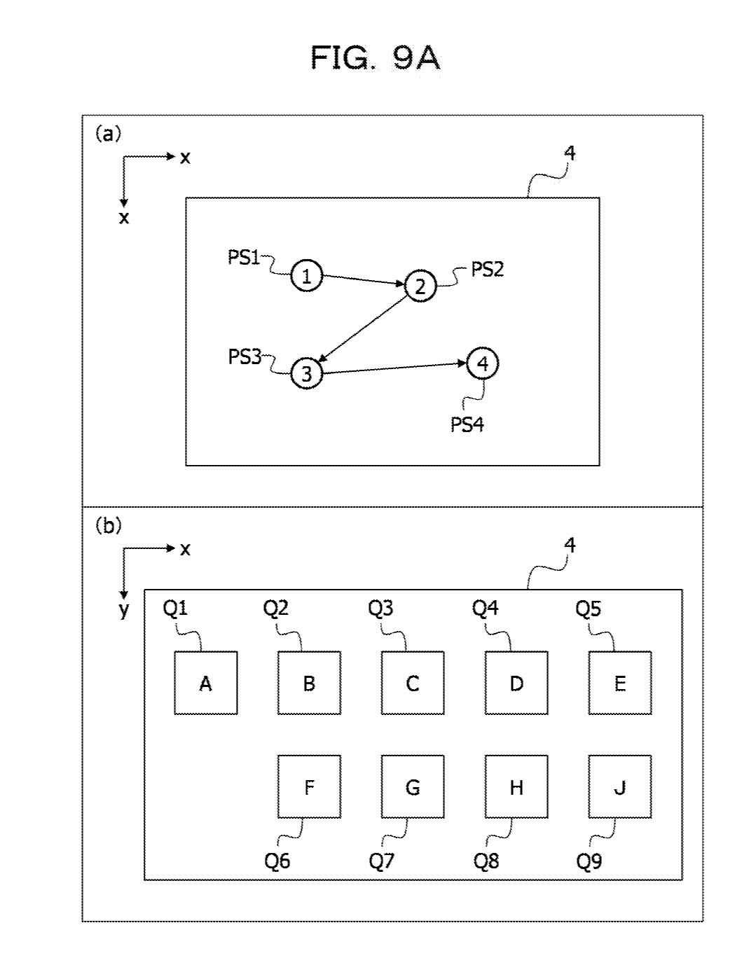

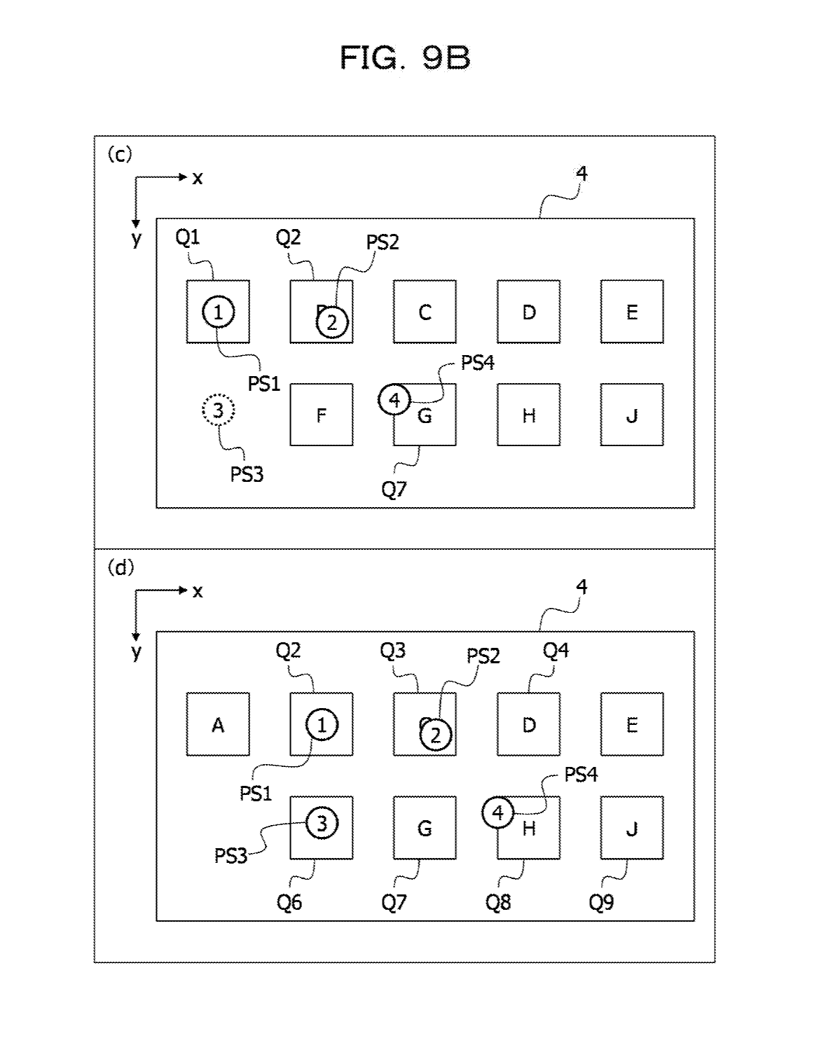

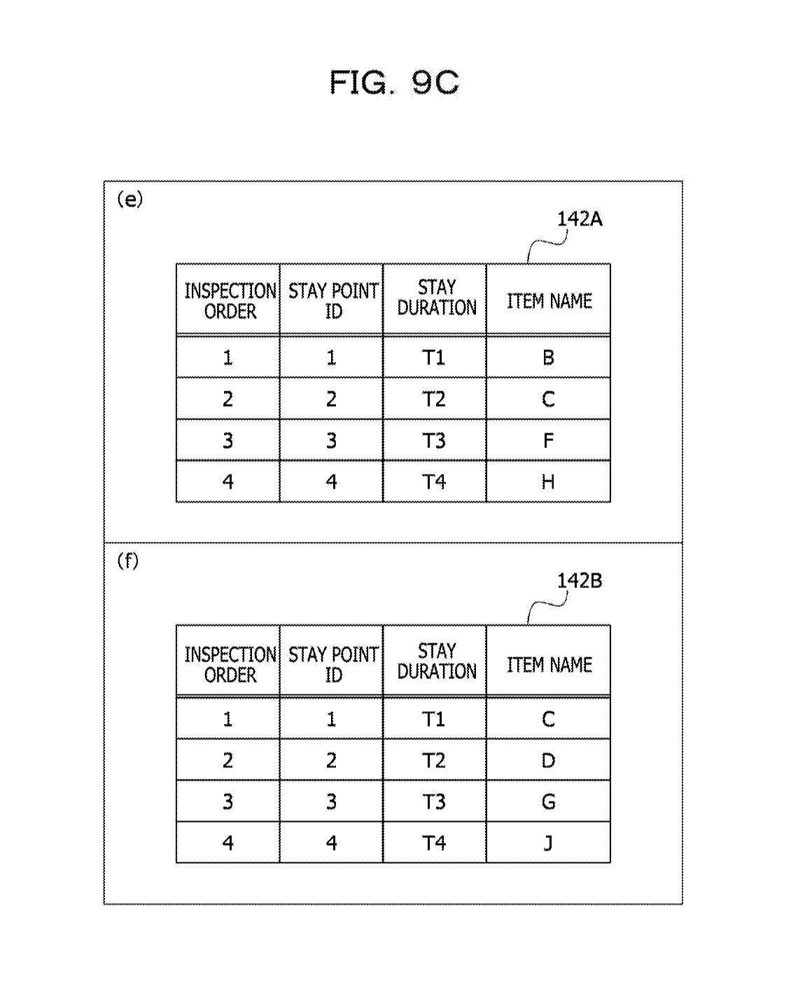

FIG. 9A is a first diagram for description of a second example of the association of each stay point with an inspection item. FIG. 9B is a second diagram for description of the second example of the association of each stay point with an inspection item. FIG. 9C is a third diagram for description of the second example of the association of each stay point with an inspection item.

The diagram (a) of FIG. 9A illustrates a sight line pattern in the plane 4 of the xy coordinate system, in other words, the positions of the stay points PS1 to PS4 and the movement sequential number thereof. In the sight line pattern illustrated in (a) of FIG. 9A, the sight line of the inspector stays at the first stay point PS1, which is the first stay point after inspection start, and then moves to the right and stays at the second stay point PS2. After staying at the second stay point PS2, the sight line of the inspector moves downward to the left, and stays at the third stay point PS3 at a position substantially identical to that of the first stay point PS1 in the horizontal direction (x direction). Thereafter, the sight line of the inspector moves to the right from the third stay point, and stays at the fourth stay point PS4 to the right of the second stay point PS2 in the horizontal direction.

The diagram (b) of FIG. 9A illustrates an arrangement pattern of inspection items Q1 to Q9 of an inspected facility in the plane 4 of the xy coordinate system. In the arrangement pattern illustrated in (b) of FIG. 9A, the five inspection items Q1 to Q5 among the nine inspection items are arranged in the horizontal direction (x direction). The remaining four inspection items Q6 to Q9 among the nine inspection items are arranged side by side in the horizontal direction below the above-described five inspection items Q1 to Q5. The four inspection items Q6 to Q9 are arranged at positions identical to those of the inspection items Q2 to Q5, respectively, in the x direction.

The five inspection items Q1 to Q5 in the top row have item names of item name A, item name B, item name C, item name D, and item name E in this order from the left. The four inspection items Q6 to Q9 in the bottom row have item names of item name F, item name G, item name H, and item name J in this order from the left. In the following description, when distinguished, the nine inspection items Q1 to Q9 are referred to as the first inspection item Q1 to the ninth inspection item Q9, respectively.

In the inspection item estimation processing according to the present embodiment, one inspection item is selected (step S602), and the first stay point (the first stay point PS1) of the sight line pattern is set on the selected inspection item to perform the association of each stay point with an inspection item (step S603). If the first inspection item Q1 is selected at step S602, the pattern comparing unit 103 sets the first stay point PS1 on the first inspection item Q1 over one another as illustrated in (c) of FIG. 9B to associate the second stay point PS2 to the fourth stay point PS4 with inspection items.

The second stay point PS2 and the third inspection item Q3 overlap with each other. Thus, when the sight line for the first stay point PS1 points to the first inspection item Q1, it is recognized that the sight line for the second stay point PS2 points to the third inspection item Q3. The fourth stay point PS4 has a center (barycenter) near the outer periphery of the seventh inspection item Q7. Thus, when the sight line for the first stay point PS1 points to the first inspection item Q1, it is recognized that the sight line for the fourth stay point PS4 points to the seventh inspection item Q7.

However, the third stay point PS3 does not overlap with any of the nine inspection items Q1 to Q9. Thus, when associating the third stay point PS3 with an inspection item, the pattern comparing unit 103 performs the processing at steps S603e to S603g illustrated in FIG. 7B. As illustrated in (c) of FIG. 9B, the third stay point PS3 is at a position substantially identical to that of the fourth stay point PS4 in the vertical direction (y direction). The distance between the first stay point PS1 and the third stay point PS3 is substantially identical to the distance between two inspection items (the second inspection item Q2 and the sixth inspection item Q6, for example) arranged in the vertical direction. In other words, the third stay point PS3 is not distant from the other stay points PS1, PS2, and PS4, but it is highly likely that the sight line for the third stay point PS3 points to any one of the inspection items Q1 to Q9. Thus, the pattern comparing unit 103 does not exclude the third stay point PS3, but associates the third stay point PS3 with information indicating no inspection item to be associated (step S603g). Accordingly, when the first stay point PS1 is set on the first inspection item Q1 are, the pattern comparing unit 103 determines that the association of each stay point with an inspection item is not achieved at step S604 (NO at step S604).

The following describes the association of each stay point with an inspection item when the second inspection item Q2 is selected at step S602. In this case, as illustrated in (d) of FIG. 9B, the pattern comparing unit 103 sets the first stay point PS1 and the second inspection item Q2 over one another to associate the second stay point PS2 to the fourth stay point PS4 with inspection items.

The second stay point PS2 and the third inspection item Q3 overlap with each other. Thus, when the sight line for the first stay point PS1 points to the second inspection item Q2, it is recognized that the sight line for the second stay point PS2 points to the third inspection item Q3. The third stay point PS3 and the sixth inspection item Q6 overlap with each other. Thus, when the sight line for the first stay point PS1 points to the second inspection item Q2, it is recognized that the sight line for the third stay point PS3 points to the sixth inspection item Q6.

The fourth stay point PS4 has a center (barycenter) near the outer periphery of the eighth inspection item Q8. Thus, when the sight line for the first stay point PS1 points to the second inspection item Q2, it is recognized that the sight line for the fourth stay point PS4 points to the eighth inspection item Q8.

In other words, when the first stay point PS1 is set on the second inspection item Q2, inspection items are associated with all stay points at which it is recognized that the inspector has watched the inspection items PS1 to PS4. Thus, the pattern comparing unit 103 determines that the association of each stay point with an inspection item is achieved at step S604 (YES at step S604). Accordingly, the pattern comparing unit 103 produces and holds an estimated pattern 142A illustrated in (e) of FIG. 9C (step S605). In the present embodiment, when the estimated pattern 142 is produced, an inspection order is associated with a stay point, an inspection item, and a stay duration. As described above, the stay duration is a duration for which the sight line stays at one stay point, and is registered in, for example, a sight line pattern 130 illustrated in FIG. 5.

The following describes the association of each stay point with an inspection item when the third inspection item Q3 is selected at step S602. In this case, the pattern comparing unit 103 sets the first stay point PS1 on the third inspection item Q3, and associates the second stay point Q2 to the fourth stay point Q4 with inspection items. When the first stay point PS1 is set on the third inspection item Q3, the stay points PS1 to PS4 and the inspection items Q1 to Q9 have, for example, such a positional relation that the stay points PS1 to PS4 illustrated in (d) of FIG. 9B are each translated to the right by an interval between the inspection items. As a result, the first stay point PS1 is associated with the third inspection item Q3, and the second stay point PS2 is associated with the fourth inspection item Q4. The third stay point PS3 is associated with the seventh inspection item Q7, and the fourth stay point PS4 is associated with the ninth inspection item Q9. Accordingly, when the third inspection item Q3 is selected at step S602, the pattern comparing unit 103 produces and holds an estimated pattern 142B illustrated in (f) of FIG. 9C (step S605).

Thereafter, the pattern comparing unit 103 sets the first stay point PS1 on each of the fourth inspection item Q4 to the ninth inspection item Q9 to perform association, but determines that the association of each stay point with an inspection item is not achieved (NO at step S604).

Consequently, in the inspection item estimation processing based on the sight line pattern illustrated in (a) of FIG. 9A and the arrangement pattern of inspection items illustrated in (b) of FIG. 9A, the first estimated pattern 142A and the second estimated pattern 142B illustrated in (e) and (f) of FIG. 9C are produced.

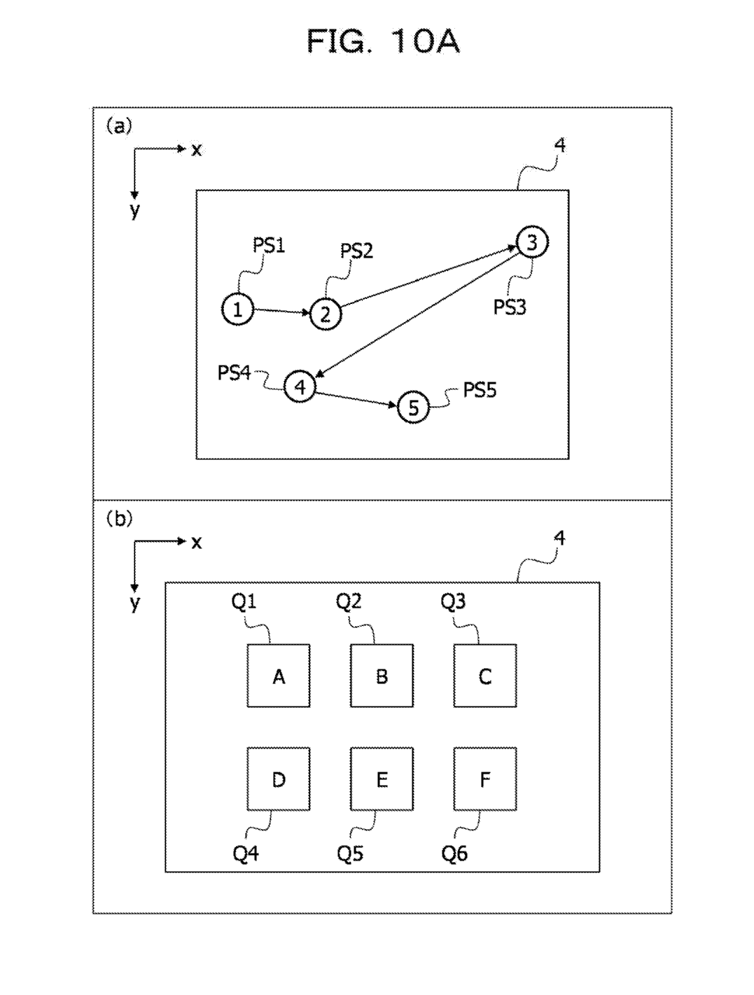

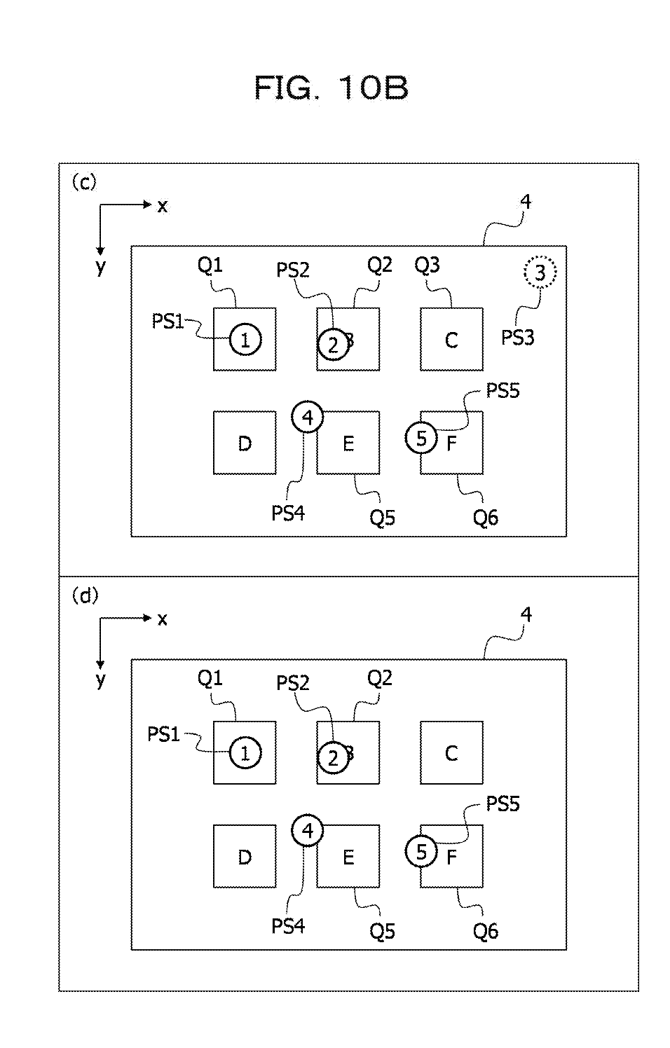

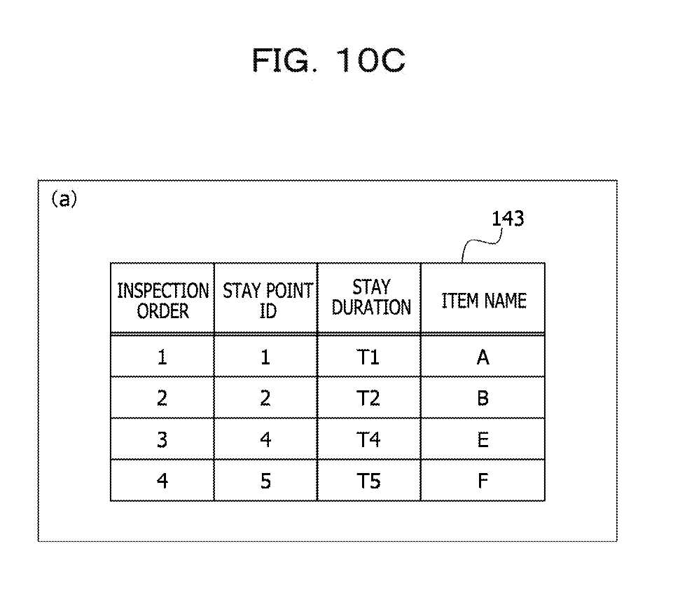

FIG. 10A is a first diagram for description of a third example of the association of each stay point with an inspection item. FIG. 10B is a second diagram for description of the third example of the association of each stay point with an inspection item. FIG. 10C is a third diagram for description of the third example of the association of each stay point with an inspection item.

The diagram (a) of FIG. 10A illustrates the positions of five stay points PS1 to PS5 and the movement sequential number thereof as an exemplary sight line pattern in the plane 4 of the xy coordinate system. In the sight line pattern illustrated in (a) of FIG. 10A, the sight line of the inspector stays at the first stay point PS1, which is the first stay point after inspection start, and then moves to the right and stays at the second stay point PS2. After staying at the second stay point PS2, the sight line of the inspector largely moves upward to the right and stays at the third stay point PS3. After staying at the third stay point PS3, the sight line of the inspector largely moves downward to the left, and stays at the fourth stay point PS4 at a position slightly to the left of the position of the second stay point PS2 in the horizontal direction (x direction). Thereafter, the sight line of the inspector moves to the right from the fourth stay point PS4, and stays at the fifth stay point PS5 up to which a moving amount the horizontal direction is substantially identical to a moving amount from the first stay point PS1 to the second stay point PS2.

The diagram (b) of FIG. 10A illustrates an arrangement pattern of the inspection items Q1 to Q6 of an inspected facility in the plane 4 of the xy coordinate system. In the arrangement pattern illustrated in (b) of FIG. 10A, the six inspection items Q1 to Q6 are arranged in a 2×3 matrix. The three inspection items Q1 to Q3 in the top row have item names of item name A, item name B, and item name C in this order from the left. The three inspection items Q4 to Q6 in the bottom row have item names of item name D, item name E, and item name F in this order from the left. In the following description, when distinguished, the inspection items Q1 to Q6 are referred to as the first inspection item Q1 to the sixth inspection item Q6, respectively.

In the inspection item estimation processing according to the present embodiment, one inspection item is selected (step S602), and the first stay point (the first stay point PS1) of the sight line pattern is set on the selected inspection item to perform the association of each stay point with an inspection item (step S603). If the first inspection item Q1 is selected at step S602, as illustrated in (c) of FIG. 10B, the pattern comparing unit 103 sets the first stay point PS1 on the first inspection item Q1 over one another, and associates the second stay point PS2 to the fifth stay point PS5 with inspection items.

The second stay point PS2 and the second inspection item Q2 overlap with each other. Thus, when the sight line for the first stay point PS1 points to the first inspection item Q1, it is recognized that the sight line for the second stay point PS2 points to the second inspection item Q2. The fourth stay point PS4 has a center (barycenter) near the outer periphery of the fifth inspection item Q5. Thus, when the sight line for the first stay point PS1 points to the first inspection item Q1, it is recognized that the sight line for the fourth stay point PS4 points to the fifth inspection item Q5. In addition, the fifth stay point PS5 has a center (barycenter) near the outer periphery of the sixth inspection item Q6. Thus, when the sight line for the first stay point PS1 points to the first inspection item Q1, it is recognized that the sight line for the fifth stay point PS5 points to the sixth inspection item Q6.

However, the third stay point PS3 does not overlap with any of the six inspection items Q1 to Q6. Thus, when associating the third stay point PS3 with an inspection item, the pattern comparing unit 103 performs the processing at steps S603e to S603g illustrated in FIG. 7B. As illustrated in (c) of FIG. 10B, the third stay point PS3 is at a position opposite to the fourth stay point PS4 and the fifth stay point PS5 with respect to the first stay point PS1 in the vertical direction. In addition, a moving amount from the fifth stay point PS5 to the third stay point PS3 in the vertical direction is substantially identical to the distance between two inspection items (the second inspection item Q2 and the fifth inspection item Q5, for example) arranged in the vertical direction.

In other words, the third stay point PS3 is distant from the other stay points PS1, PS2, PS4, and PS5, and thus it is highly likely that the sight line for the third stay point PS3 points to a place different from the inspection items Q1 to Q6. Accordingly, as illustrated in (d) of FIG. 10B, the pattern comparing unit 103 excludes the third stay point PS3 from the sight line pattern (step S603f). In other words, the pattern comparing unit 103 performs the association of each stay point with an inspection item for the four stay points PS1, except for the third stay point PS3 among the five stay points PS1 to PS5, PS2, PS4, and PS5, as stay points when the inspector inspects inspection items. The four stay points PS1, PS2, PS4, and PS5 except for the third stay point PS3 are each associated with an inspection item as described above. Thus, when the first stay point PS1 is set on the first inspection item Q1, the pattern comparing unit 103 determines that the association of each stay point with an inspection item is achieved at step S604 (YES at step S604). Accordingly, the pattern comparing unit 103 produces and holds an estimated pattern 143 illustrated in (e) of FIG. 10C (step S605).

The following describes the association of each stay point with an inspection item when the second inspection item Q2 is selected at step S602. In this case, the stay points PS1, PS2, PS4, and PS5 in the plane 4 and the inspection items Q1 to Q6 have such a positional relation that the stay points PS1, PS2, PS4, and PS5 illustrated in (d) of FIG. 10B are each translated to the right by an interval between the inspection items. Accordingly, the first stay point PS1 is associated with the second inspection item Q2, and the second stay point PS2 is associated with the third inspection item Q3. The fourth stay point PS4 is associated with the sixth inspection item Q6.

However, when the first stay point PS1 is set on the second inspection item Q2, no inspection item is associated with the fifth stay point PS5. Accordingly, when the first stay point PS1 is set on the first inspection item Q1, the pattern comparing unit 103 determines that the association of each stay point with an inspection item is not achieved at step S604 (NO at step S604).

When the first stay point PS1 is set on each of the third inspection item Q3 to the sixth inspection item Q6, too, the pattern comparing unit 103 determines that the association of each stay point with an inspection item is not achieved at step S604 (NO at step S604).

Consequently, in the inspection item estimation processing based on the sight line pattern illustrated in (a) of FIG. 10A and the arrangement pattern of inspection items illustrated in (b) of FIG. 10A, only the one estimated pattern 143 illustrated in (e) of FIG. 10C is produced. In addition, the pattern comparing unit 103 performs the association of a stay point and an inspection point with each other while excluding any stay point distant from other stay points by a distance larger than a predetermined threshold, such as the third stay point PS3 in the sight line pattern illustrated in (a) of FIG. 10A, from the sight line pattern. Thus, it is possible to avoid such a situation that the association of a stay point and an inspection point with each other fails because the sight line pattern includes a stay point obtained when the inspector watched a place different from any inspection item during inspection.

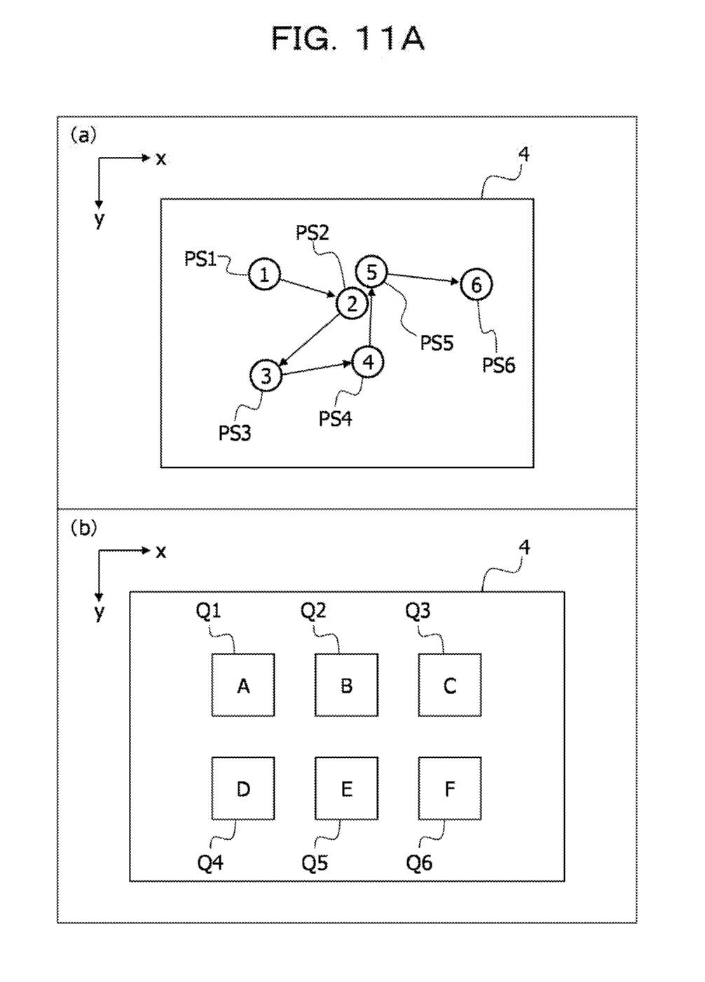

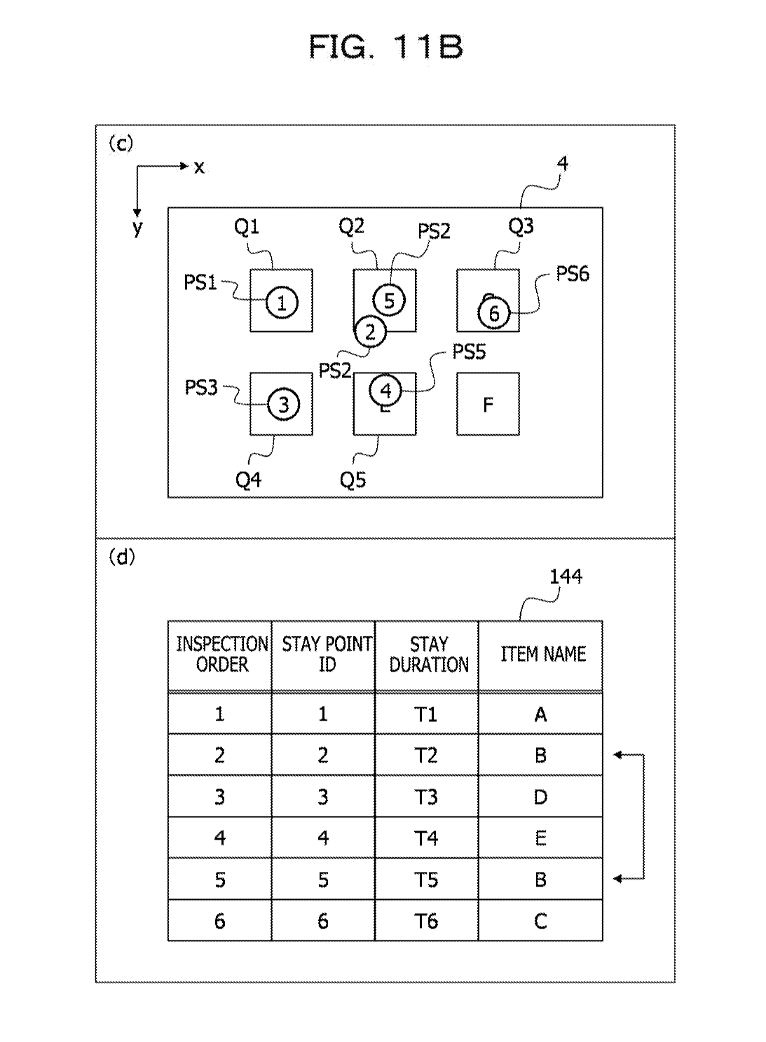

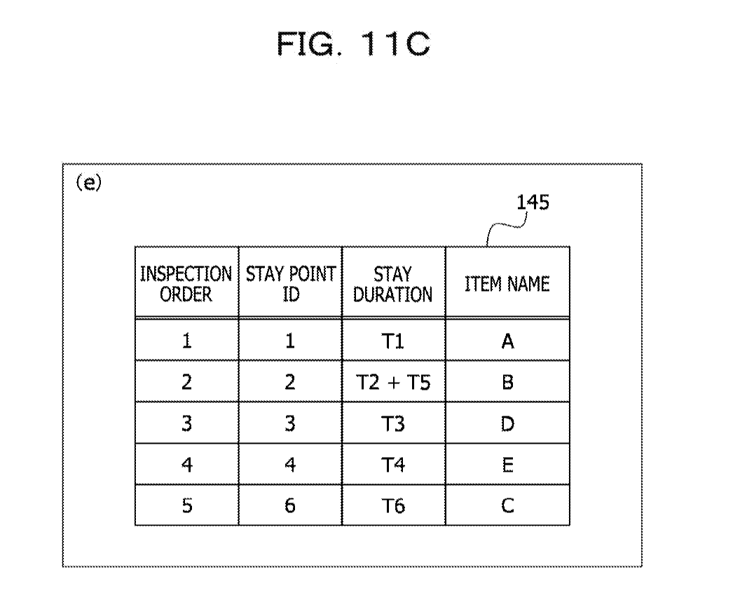

FIG. 11A is a first diagram for description of a fourth example of the association of each stay point with an inspection item. FIG. 11B is a second diagram for description of the fourth example of the association of each stay point with an inspection item. FIG. 11C is a third diagram for description of the fourth example of the association of each stay point with an inspection item.

The diagram (a) of FIG. 11A illustrates a sight line pattern in the plane 4 of the xy coordinate system, in other words, the positions of six stay points PS1 to PS6 and the movement sequential number thereof. In the sight line pattern illustrated in (a) of FIG. 11A, the sight line of the inspector stays at the first stay point PS1, which is the first stay point after inspection start, and then moves to the right and stays at the second stay point PS2. After staying at the second stay point PS2, the sight line of the inspector moves downward to the left, and stays at the third stay point PS3 at a position substantially identical to that of the first stay point PS1 in the horizontal direction (x direction). After staying at the third stay point PS3, the sight line of the inspector moves to the right, and stays at the fourth stay point PS4 slightly to the right of the second stay point PS2 in the horizontal direction. After staying at the fourth stay point PS4, the sight line of the inspector moves upward substantially in the vertical direction (y direction), and stays at the fifth stay point PS5 slightly above the second stay point PS2 in the vertical direction. After staying at the fifth stay point PS5, the sight line of the inspector moves to the right and stays at the sixth stay point PS6. A moving amount from the fifth stay point PS5 to the sixth stay point PS6 in the horizontal direction is substantially identical to, for example, a moving amount from the first stay point PS1 to the second stay point PS2 in the horizontal direction, and a moving amount from the third stay point PS3 to the fourth stay point PS4 in the horizontal direction.

The diagram (b) of FIG. 11A illustrates an arrangement pattern of the inspection items Q1 to Q6 of an inspected facility in the plane 4 of the xy coordinate system. In the arrangement pattern illustrated in (b) of FIG. 11A, the six inspection items Q1 to Q6 are arranged in a 2×3 matrix. The three inspection items Q1 to Q3 in the top row have item names of item name A, item name B, and item name C in this order from the left. The three inspection items Q4 to Q6 in the bottom row have item names of item name D, item name E, and item name F in this order from the left. In the following description, when distinguished, the inspection items Q1 to Q6 are referred to as the first inspection item Q1 to the sixth inspection item Q6, respectively.

In the inspection item estimation processing according to the present embodiment, one inspection item is selected (step S602), and the first stay point (the first stay point PS1) of the sight line pattern and the selected inspection item are placed over one another to perform the association of each stay point with an inspection item (step S603). If the first inspection item Q1 is selected at step S602, the pattern comparing unit 103 sets the first stay point PS1 on the first inspection item Q1 as illustrated in (c) of FIG. 11B to associate the second stay point PS2 to the sixth stay point PS6 with inspection items.

The second stay point PS2 has a center (barycenter) near the outer periphery of the second inspection item Q2. Thus, when the sight line for the first stay point PS1 points to the first inspection item Q1, it is recognized that the sight line for the second stay point PS2 points to the second inspection item Q2. The third stay point PS3 and the fourth inspection item Q4 overlap with each other. Thus, when the sight line for the first stay point PS1 points to the first inspection item Q1, it is recognized that the sight line for the third stay point PS3 points to the fourth inspection item Q4. The fourth stay point PS4 and the fifth inspection item Q5 overlap with each other. Thus, when the sight line for the first stay point PS1 points to the first inspection item Q1, it is recognized that the sight line for the fourth stay point PS4 points to the fifth inspection item Q5.

In addition, the fifth stay point PS5 and the second inspection item Q2 overlap with each other. Thus, when the sight line for the first stay point PS1 points to the first inspection item Q1, it is recognized that the sight line for the fifth stay point PS5 points to the second inspection item Q2.

In addition, the sixth stay point PS6 and the third inspection item Q3 overlap with each other. Thus, when the sight line for the first stay point PS1 points to the first inspection item Q1, it is recognized that the sight line for the sixth stay point PS6 points to the third inspection item Q3.

In other words, when the first stay point PS1 and the first inspection item Q1 are placed over one another, inspection items are associated with all stay points at which it is recognized that the inspector has watched the inspection items PS1 to PS6. Thus, having completed the processing at steps S603a to S603i performed by placing the first stay point PS1 and the first inspection item Q1 over one another, the pattern comparing unit 103 obtains, for example, an estimated pattern 144 illustrated in (d) of FIG. 11B.

However, in the estimated pattern 144, the second inspection item Q2 having item name B is inspected twice. When one inspection item is inspected multiple times at one inspection in this manner, for example, another inspection item is potentially watched between two inspection items specified to be sequentially inspected, causing error in the inspection order. For this reason, in the present embodiment, processing (step S603j) of integrating multiple stay points associated with an identical inspection item is performed as illustrated in FIG. 7A. At step S603j, the pattern comparing unit 103 integrates a correspondence relation for an inspection order of “2nd” and a correspondence relation for an inspection order of “5th”, which are associated with the inspection item having item name B in the estimated pattern 144 illustrated in (d) of FIG. 11B, to one of the correspondence relations. When integrating the correspondence relations, the pattern comparing unit 103 performs the integration to an inspection item inspected at the earliest place, for example. When performing the integration to a correspondence relation for an earliest inspection order, the pattern comparing unit 103 changes the estimated pattern 144 to an estimated pattern 145 illustrated in (e) of FIG. 11C. Specifically, the pattern comparing unit 103 changes the correspondence relation for an inspection order of “5th” from a correspondence relation between (stay point ID)=5 and item name B to a correspondence relation between (stay point ID)=6 and item name C. When integrating the correspondence relation between (stay point ID)=5 and item name B with a correspondence relation between (stay point ID)=2 and item name B for an inspection order of “2nd”, the pattern comparing unit 103 adds stay duration T5 to stay duration T2. Accordingly, it is indicated that the inspection item having item name B is inspected at the second place after inspection is started and a time taken for the inspection is T2+T5.

When correspondence relations are integrated, the integration may be performed to, for example, a correspondence relation with the longest stay duration. Through the integration to a correspondence relation with the longest stay duration, the estimated pattern 144 illustrated in (d) of FIG. 11B is changed to an estimated pattern indicating that inspection is sequentially performed on inspection items with item name A, item name D, item name E, item name B, and item name C.

As described above, in the inspection item estimation processing according to the present embodiment, any stay point disabling identification of items inspected by the inspector and the order of the inspection is excluded as a target of association with an inspection item. This can increase the accuracy of estimation of an object (inspection item) actually watched by the inspector.

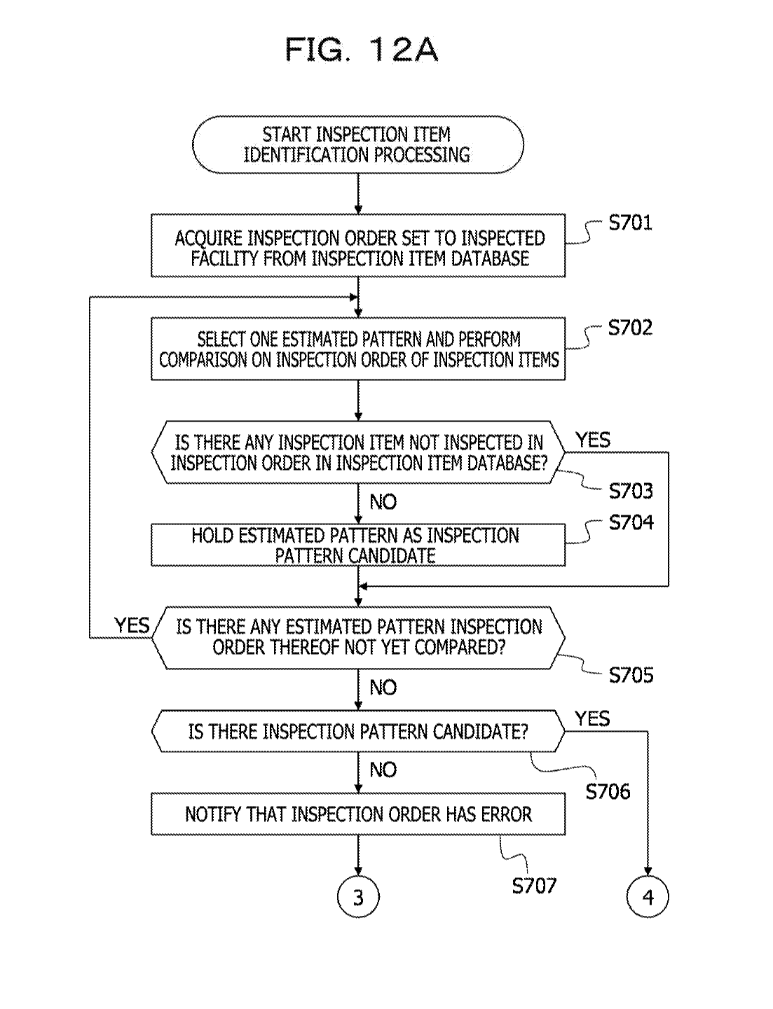

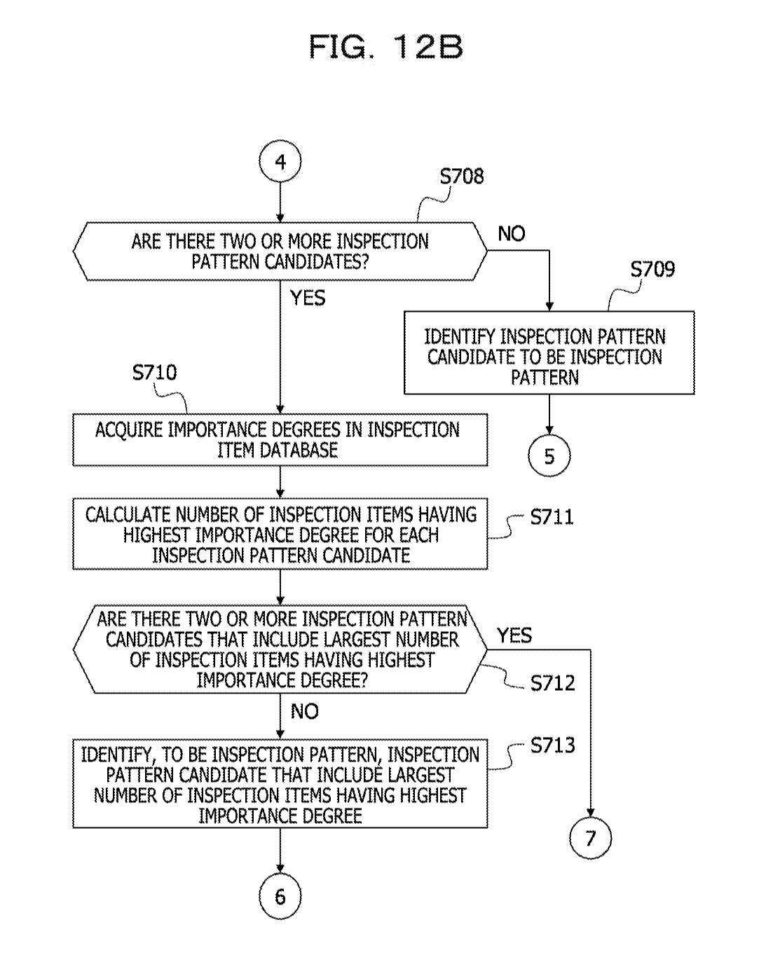

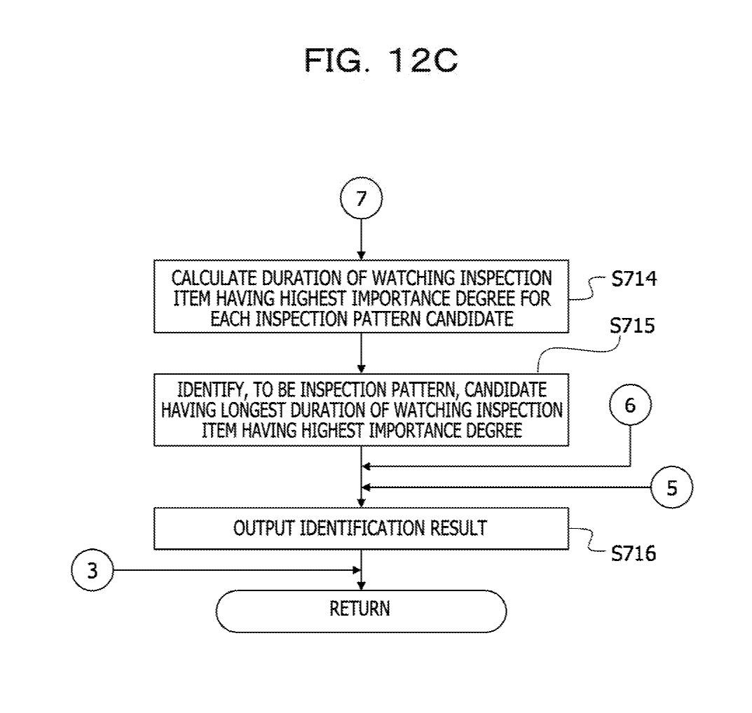

Then, having completed the inspection item estimation processing, the inspection supporting apparatus 1 next performs the inspection item identification processing (step S7) of identifying, from an estimated pattern, items inspected by the inspector and the order of the inspection. The inspection item identification processing is performed by the inspection item identifying unit 104. The inspection supporting apparatus 1 according to the present embodiment (the inspection item identifying unit 104) performs processing illustrated in FIGS. 12A to 12C as the inspection item identification processing.

FIG. 12A is a first flowchart for description of the content of the inspection item identification processing according to the first embodiment. FIG. 12B is a second flowchart for description of the content of the inspection item identification processing according to the first embodiment. FIG. 12C is a third flowchart for description of the content of the inspection item identification processing according to the first embodiment.

When having started the inspection item identification processing, as illustrated in FIG. 12A, the inspection item identifying unit 104 first acquires an inspection order set to an inspected facility from the inspection item database 110 (step S701). At step S701, the inspection item identifying unit 104 uses, for example, a facility ID input to the inspection supporting apparatus 1 at start of inspection as key information to read and acquire information on an inspection order associated with the facility ID from the inspection item database 110. When the inspection supporting apparatus 1 is provided to each inspected facility and only inspection items of one facility and the coordinates thereof are registered in the inspection item database 110, the inspection item identifying unit 104 reads information on a registered inspection order.

Subsequently, the inspection item identifying unit 104 selects one estimated pattern and performs comparison on the inspection order of inspection items (step S702). At step S702, the inspection item identifying unit 104 selects one estimated pattern according to the predetermined selection rule. According to the selection rule, for example, an estimated pattern having the smallest pattern ID is selected from among estimated patterns not selected at step S702. At step S702, the inspection item identifying unit 104 determines whether the estimated pattern includes an inspection item to which an inspection order is set in the inspection item database 110. If the estimated pattern includes two or more inspection items to each of which an inspection order is set, the inspection item identifying unit 104 performs comparison on the inspection order of the two or more inspection items.

After step S702, the inspection item identifying unit 104 determines whether there is any inspection items not inspected according to the inspection order in the inspection item database (step S703). If the estimated pattern includes two or more inspection items the inspection order of which is specified and the two or more inspection items are not inspected in the specified inspection order in the inspection item database, the inspection item identifying unit 104 determines “YES” at step S703.

In other words, the inspection item identifying unit 104 determines “NO” at step S703 in any one of three cases described below.

(1) No inspection order is specified for the inspection items of the inspected facility in the inspection item database 110.

(2) There is zero or one inspection item the inspection order of which is specified in the estimated pattern.

(3) The inspection order of two or more inspection items, which is specified in the estimated pattern, matches with the inspection order in the inspection item database.

If the determination at step S703 provides “NO”, the inspection item identifying unit 104 holds the estimated pattern as an inspection pattern candidate (step S704). After step S704, the inspection item identifying unit 104 determines whether there is any estimated pattern the inspection order thereof is not compared (step S705).

If there is any inspection item not inspected according to the inspection order in the inspection item database (YES at step S703), the inspection item identifying unit 104 skips step S704 and performs the determination at step S705.

If there is any estimated pattern the inspection order thereof is not compared (YES at step S705), the inspection item identifying unit 104 repeats the processing at step S702 and later. Then, if the inspection order comparison is performed for all estimated patterns (NO at step S705), the inspection item identifying unit 104 next determines whether there is any inspection pattern candidate (step S706).

If there is no inspection pattern candidate (NO at step S706), the inspection item identifying unit 104 notifies the output unit 105 that, for example, the inspection order has an error (step S707). Having completed the notification at step S707, the inspection item identifying unit 104 ends the inspection item identification processing as illustrated in FIG. 12C (return).

If there is any inspection pattern candidate (YES at step S706), the inspection item identifying unit 104 next determines whether there are two or more inspection pattern candidates (step S708).

If there is one inspection pattern candidate (NO at step S708), the inspection item identifying unit 104 identifies this inspection pattern candidate to be an inspection pattern (step S709). In other words, if there is one inspection pattern candidate, the inspection item identifying unit 104 identifies inspection items registered in this inspection pattern candidate to be items inspected by the inspector. Having identified the inspection pattern at step S709, the inspection item identifying unit 104 outputs an identification result (such as the identified inspection pattern) (step S716) and ends the inspection item identification processing as illustrated in FIG. 12C (return).

If there are two or more inspection pattern candidates (YES at step S708), the inspection item identifying unit 104 next acquires importance degrees in the inspection item database (step S710).

Having acquired the importance degrees in the inspection item database 110, the inspection item identifying unit 104 calculates the number of inspection items having the highest importance degree for each inspection pattern candidate (step S711). When there are the three importance degrees of “requisite”, “important”, and blank like the inspection item database 110A illustrated in FIG. 2, the inspection item identifying unit 104 calculates the number of inspection items having an importance degree of “requisite” in each inspection pattern candidate at step S711.

Subsequently, the inspection item identifying unit 104 determines whether there are two or more inspection pattern candidates including the largest number of inspection items having the highest importance degree (step S712). If the number of such inspection patterns is one (NO at step S712), the inspection item identifying unit 104 next identifies, to be an inspection pattern, an inspection pattern candidate including the largest number of inspection items having the highest importance degree (step S713). Having identified the inspection pattern at step S713, the inspection item identifying unit 104 outputs an identification result (step S716) and ends the inspection item identification processing as illustrated in FIG. 12C (return).

If the number of such inspection pattern candidates is two or more (YES at step S712), the inspection item identifying unit 104 next calculates a duration for which an inspection item having the highest importance degree has watched for each inspection pattern candidate as illustrated in FIG. 12C (step S714). At step S714, the inspection item identifying unit 104 calculates the sum of the stay duration at a stay point associated with each inspection item having an importance degree of “requisite” in the inspection pattern candidate (estimated pattern).

Subsequently, the inspection item identifying unit 104 identifies, among the inspection pattern candidates, a candidate having the longest duration for which an inspection item having the highest importance degree has watched, to be an inspection pattern (step S715). Having identified the inspection pattern at step S715, the inspection item identifying unit 104 outputs an identification result (step S716), and ends the inspection item identification processing (return).

In the first example of the association of each stay point with an inspection item illustrated in FIGS. 8A to 8C, there is one estimated pattern as illustrated in (d) of FIG. 8B. Thus, in a case in which the inspection item identification processing is performed based on this first example, the estimated pattern 141 is identified to be an inspection pattern if the inspection order of inspection items in the estimated pattern 141 illustrated in (d) of FIG. 8B matches with the order specified in the inspection item database (step S709). When the inspection item database 110 is the inspection item database 110A illustrated in FIG. 2 and the inspector inspects the facility having a facility ID of “1”, an inspection order is registered only for the inspection item having item name A and the inspection item having item name B. The inspection order of the inspection item having item name A and the inspection item having item name B specifies that the inspection item having item name A is inspected, and then the inspection item having item name B is inspected.

In the estimated pattern 141 illustrated in (d) of FIG. 8B, the inspection item having item name A is inspected, and then the inspection item having item name B is inspected. Thus, the inspection order of inspection items in the estimated pattern 141 matches with the order specified in the inspection item database, and the estimated pattern 141 is identified to be an inspection pattern (step S709).

When an inspection order is specified in inspection work on a facility, the inspector gazes at inspection items in the specified order. Thus, in the inspection item identification processing according to the present embodiment, when multiple inspection patterns correspond to a sight line pattern of the inspector, an inspection pattern in which the gazing is achieved at the inspection items in the specified order among multiple estimated patterns is identified to be the actual inspection pattern of the inspector.

When the importance degree is set to each inspection item in inspection work on a facility, the inspector gazes at an inspection item having the highest importance degree. Thus, in the inspection item identification processing according to the present embodiment, when one inspection pattern may not be identified based on an inspection order, an inspection pattern having the largest number of inspection items having the highest importance degree is identified to be the actual inspection pattern of the inspector.

When the importance degree is set to each inspection item in inspection work on a facility, the inspector tends to spend a longer inspection time on an inspection item having the highest importance degree than an inspection time on any other inspection item. Thus, in the inspection item identification processing according to the present embodiment, when one inspection pattern may not be identified based on the importance degree, an inspection pattern having the longest duration for which an inspection item having the highest importance degree has watched is identified to be the actual inspection pattern of the inspector.

In this manner, in the inspection item identification processing according to the present embodiment, one inspection pattern is identified from among multiple inspection pattern candidates based on the tendency of inspection work by the inspector when an inspection order and an importance degree are set to an inspection item. In this manner, an object (inspected item) actually watched by the inspector can be correctly identified from among multiple objects (inspection items) having similar appearances and arrangement patterns.

The processing steps S702 to S705 in FIG. 12A is processing based on an assumption that inspection orders are set to all facilities registered in the inspection item database 110. However, a facility to which no inspection order is set may be registered in the inspection item database 110. Accordingly, at step S701, no inspection order is acquired from the inspection item database 110 in some cases. Thus, although not illustrated in FIG. 12A, if no inspection order is acquired at step S701 (in other words, no inspection order is set to an inspected facility), the inspection item identifying unit 104 sets all estimated patterns as inspection pattern candidates, and performs the determination at step S708.

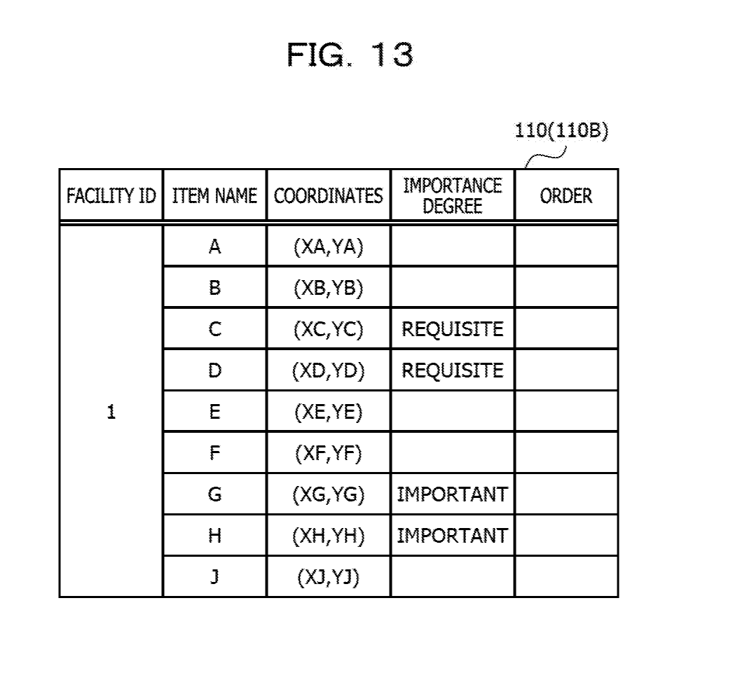

FIG. 13 is a diagram illustrating a second exemplary inspection item database.

FIG. 13 illustrates, as a second example of the inspection item database 110, an inspection item database 110B for a facility including the inspection items Q1 to Q9 illustrated in (b) of FIG. 9A. Nine inspection items having item names A to H and J are registered in the inspection item database 1108. Among the nine inspection items, the importance degrees of an inspection item having item name C and an inspection item having item name D are specified to be “requisite”, and the importance degrees of an inspection item having item name G and an inspection item having item name H are specified to be “important”. No inspection order is specified for the nine inspection items.

In the above-described second example of the association of each stay point with an inspection item, as illustrated in (e) and (f) of FIG. 9C, the two estimated patterns 142A and 142B are extracted. Thus, when the inspection item identification processing is performed based on this second example of the association, it is first determined whether there is any inspection item not inspected in an inspection order specified in the inspection item database 110B for each estimated pattern (steps S702 and S703).

However, the inspection item database 110B includes no inspection item for which an inspection order is specified. Thus, the inspection item identifying unit 104 sets both of the two estimated patterns 142A and 142B to be inspection pattern candidates as described above. Accordingly, the inspection item identifying unit 104 next calculates the number of inspection items having an importance degree of “requisite” in each of the two estimated patterns 142A and 142B (step S711). In the inspection item database 110B, the inspection item having item name C and the inspection item having item name D have an importance degree of “requisite”. Thus, in the first estimated pattern 142A in which inspection is performed on inspection items having item names B, C, F, and H, the number of inspection items having an importance degree of “requisite” is one. In the second estimated pattern 142B in which inspection is performed on the inspection items having item names C, D, G, and J, the number of inspection items having an importance degree of “requisite” is two. Accordingly, the inspection item identifying unit 104 identifies the second estimated pattern 142B (inspection pattern candidate) to be an inspection pattern (step S713).

For example, when the importance degree of any of inspection items having item names B in the inspection item database 110B, F, and H is “requisite”, the number of inspection items having an importance degree of “requisite” is two for each of the two estimated patterns 142A and 142B. In such a case, the inspection item identifying unit 104 next calculates, for each estimated pattern, a duration (in other words, a stay duration) for which each inspection item having an importance degree of “requisite” has been watched, and identifies an estimated pattern for which the calculated duration is longer to be an inspection pattern (steps S714 and S715). For example, when the inspection items having item names C, D, and F in the inspection item database 1108 have importance degrees of “requisite”, a duration for which each inspection item having an importance degree of “requisite” in the first estimated pattern 142A has been watched is (T2+T3) seconds. A duration for which each inspection item having an importance degree of “requisite” in the second estimated pattern 142B has been watched is (T1+T2) seconds. Accordingly, when the stay duration of T1 seconds at a stay point having a stay point ID of “1” is longer than the stay duration of T3 seconds at a stay point having a stay point ID of “3”, the inspection item identifying unit 104 identifies the second estimated pattern 142B to be an inspection pattern. In contrast, when the stay duration of T3 seconds at the stay point having a stay point ID of “3” is longer than the stay duration of T1 seconds at the stay point having a stay point ID of “1”, the inspection item identifying unit 104 identifies the first estimated pattern 142A to be an inspection pattern.

In the present embodiment, when multiple inspection patterns are estimated based on the inspection item database 110 and a sight line pattern produced based on information acquired from the sight line sensor 2, one of the estimated patterns is identified. However, the processing performed by the inspection supporting apparatus 1 (sight line identification apparatus) according to the present embodiment can be understood as follows. First, the inspection supporting apparatus 1 identifies the direction of a sight line based on information acquired from the sight line sensor. Subsequently, the inspection supporting apparatus 1 estimates an object positioned in the identified direction of the sight line by referring to an arrangement relation (the inspection item database 110, for example) between multiple objects. Thereafter, the inspection supporting apparatus 1 corrects the identified direction of the sight line based on a transition order of the estimated object and data on an order of objects pointed to by a sight line stored in a storage apparatus. When the processing performed by the inspection supporting apparatus 1 according to the present embodiment is understood as correction of the identified direction of the sight line as described above, the sight line pattern producing unit 102 in the inspection supporting apparatus 1 is an identifying unit configured to perform the processing of identifying the direction of the sight line. The pattern comparing unit 103 in the inspection supporting apparatus 1 is an estimating unit configured to perform the processing of estimating an object positioned in the identified direction of the sight line by referring to an arrangement relation (the inspection item database 110) between multiple objects stored in a storage unit. The inspection item identifying unit 104 in the inspection supporting apparatus 1 is a correcting unit configured to correct the identified direction of the sight line based on a transition order of the estimated object and data on an order of objects pointed to by a sight line (the inspection item database 110) stored in the storage unit.

### Second Embodiment

The present embodiment describes another example of the inspection item identification processing performed by the inspection item identifying unit 104 in the inspection supporting apparatus 1 illustrated in FIG. 1.

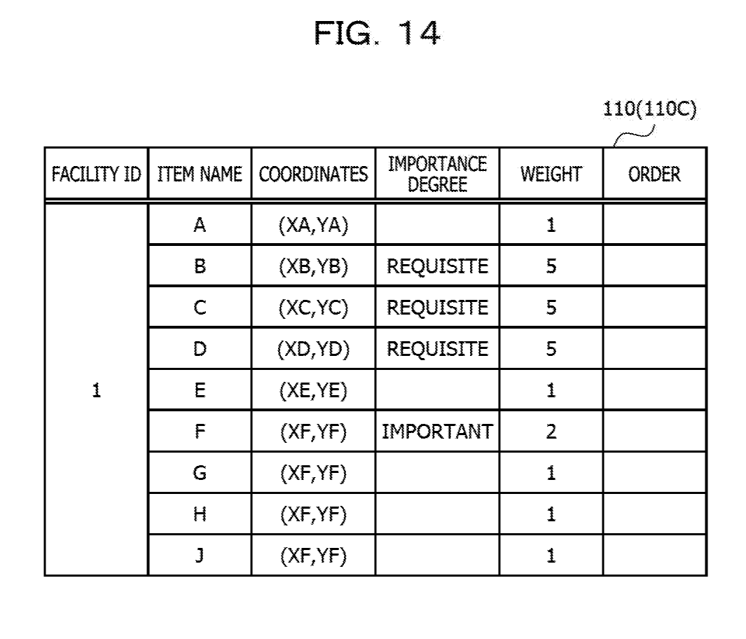

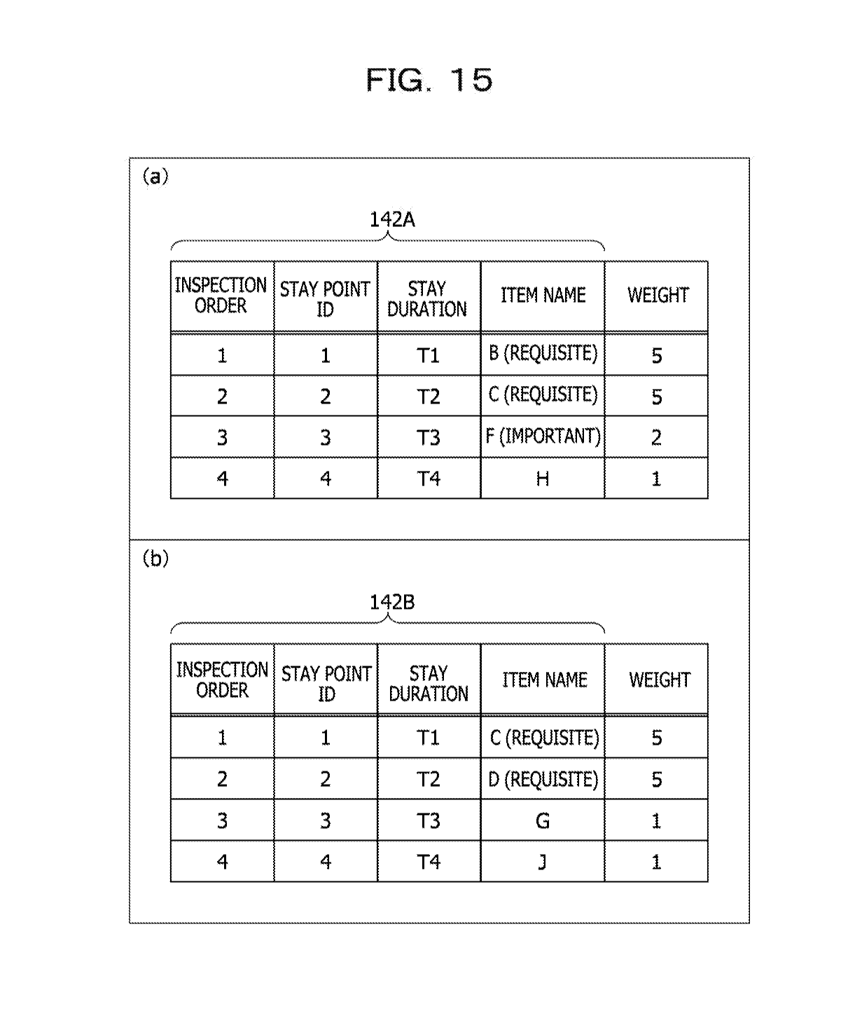

FIG. 14 is a diagram illustrating a third example of the inspection item database. FIG. 15 is a diagram illustrating estimated patterns and weights in the second example of the association of each stay point with an inspection item

FIG. 14 illustrates, as the third example of the inspection item database 110, an inspection item database 110C for the facility including the inspection items Q1 to Q9 illustrated in (b) of FIG. 9A. The nine inspection items having item names A to H and J are registered in the inspection item database 110C. In the inspection item database 110C, among the nine inspection items, the importance degrees of the three inspection items having item names B, C, and D are specified to be “requisite”, and the importance degree of the inspection item having item name F is specified to be “important”. No inspection order is specified for the nine inspection items.

In addition, the inspection item database 110C adds, to the item name (inspection item), information on a weight in accordance with the importance degree thereof. The weight in the inspection item database 110C is a value obtained by quantifying the importance degree, and a larger weight (numerical value) is associated with an inspection item having a higher importance degree. In the example illustrated in FIG. 14, the weight of “5” is set to an item name having the highest importance degree of “requisite” as described above. The weight of “2” is set to an item name having a second highest importance degree of “important”. The weight of “1” is set to an item name having the lowest importance degree of “blank”.

In the above-described second example of the association of each stay point with an inspection item, the two estimated patterns 142A and 142B are extracted as illustrated in (e) and (f) of FIG. 9C. Among the importance degrees of item names (inspection items) in the first estimated pattern 142A, which are acquired by referring to the inspection item database 110C, only the importance degrees of item names B and C are “requisite” as illustrated in (a) of FIG. 15. Similarly, among the importance degrees of item names (inspection items) in the second estimated pattern 142B, which are acquired by referring to the inspection item database 110C, the importance degrees of item names C and D are “requisite” as illustrated in (b) of FIG. 15. Accordingly, in the inspection item identification processing according to the first embodiment, the two item names have the importance degree of “requisite” in each of the two estimated patterns 142A and 142B. In addition, a duration for which the item names (inspection item) having the importance degree of “requisite” have been watched is (T1+T2) for each of the two estimated patterns 142A and 142B. In this manner, in the inspection item identification processing according to the first embodiment, it is potentially difficult to identify one inspection pattern from among multiple estimated patterns in some cases.

Thus, in the inspection item identification processing according to the present embodiment, identification of an inspection pattern is performed based on weights in the inspection item database 110C when the same number of item names have the importance degree of “requisite” among multiple estimated patterns (inspection pattern candidates). Specifically, the product of a watching duration (stay duration) and a weight is calculated for each item name (inspection item) in an estimated pattern, and then the sum of the products is calculated. Then, an estimated pattern having the largest sum of products of watching durations and weights is identified to be an inspection pattern.

In the inspection item database 110C, the weight of “5” is set to each of item names B and C. In the inspection item database 110C, the weights of “2” and “1” are set to item names F and H, respectively. In other words, as illustrated in (a) of FIG. 15, the weights of “5”, “5”, “2”, and “1” are associated with item names B, C, F, and H in the first estimated pattern 142A, respectively. The weights of “5”, “5”, “1”, and “1” are associated with item names B, C, F, and H in the second estimated pattern 142B, respectively, as illustrated in (b) of FIG. 15. Thus, a sum R1 of each product of a watching duration and a weight in the first estimated pattern 142A, and a sum R2 of each product of a watching duration and a weight in the second estimated pattern 142B are calculated by Expressions (1-1) and (1-2) below, respectively.

R1=(T1×5)+(T2×5)+(T3×2)+(T4×1) (1-1)

R2=(T1×5)+(T2×5)+(T3×1)+(T4×1) (1-2)

In Expressions (1-1) and (1-2), the first term, the second term, and the fourth term on the right hand side have identical values. Value T3 in the third term on the right hand side in Expressions (1-1) and (1-2) is a stay duration (duration for which an inspection item has been watched) of a sight line, and T3>0 holds. Thus, the sums R1 and R2 calculated based on the inspection item database 110C and the estimated patterns 142A and 142B holds the relation of R1>R2. Accordingly, the inspection item identifying unit 104 identifies the first estimated pattern 142A to be an inspection pattern.

In this manner, in the inspection item identification processing according to the present embodiment, when an inspection pattern may not be identified based only on the number of inspection items having an importance degree of “requisite” and durations for which these items have been watched, an inspection pattern is identified by using the importance degree (weight) of an item, which is different from “requisite”. In other words, according to the present embodiment, inspection items actually watched by the inspector and the inspection order thereof can be correctly identified from multiple inspection patterns between which the number of inspection items having an importance degree of “requisite” and durations for which these items have been watched are identical.

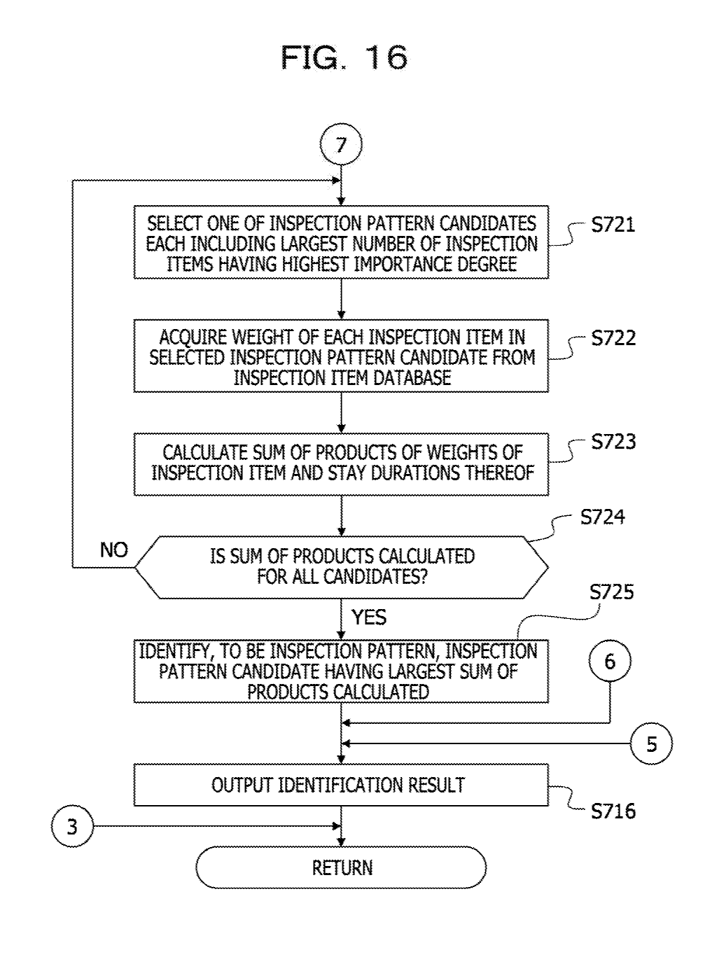

FIG. 16 is a flowchart for description of part of the inspection item identification processing according to the second embodiment.

In the inspection item identification processing according to the present embodiment, the processing steps S701 to S707 illustrated in FIG. 12A and the processing steps S708 to S713 illustrated in FIG. 12B are first performed. The processing steps S701 to S713 are as described in the first embodiment. Then, at step S712, if it is determined that there are two or more inspection pattern candidates each including the largest number of inspection items having the highest importance degree (YES at step S712), the inspection item identifying unit 104 next performs processing at step S721 and later illustrated in FIG. 16.

If there are two or more inspection pattern candidates each including the largest number of inspection items having the highest importance degree, the inspection item identifying unit 104 next selects one of the inspection pattern candidates each including the largest number of inspection items having the highest importance degree (step S721). At step S721, the inspection item identifying unit 104 selects one of the inspection pattern candidates corresponding to a predetermined selection rule. According to the selection rule at step S721, for example, an inspection pattern candidate having the highest extraction order is selected from among inspection pattern candidates not selected at step S721.

Subsequently, the inspection item identifying unit 104 acquires a weight of each inspection item in the selected inspection pattern candidate from the inspection item database 110C (step S722), and calculates the sum of each product of the weight of the inspection item and a stay duration thereof (step S723).

Subsequently, the inspection item identifying unit 104 determines whether the sum of each product of the weight of the inspection item and the stay duration thereof is calculated for all candidates (step S724). If there is any inspection pattern candidate for which the sum of each product of the weight of the inspection item and the stay duration thereof is not calculated (NO at step S724), the inspection item identifying unit 104 repeats the processing at step S721 and later.

Then, if the sum of each product of the weight of the inspection item and the stay duration thereof is calculated for all inspection pattern candidates (YES at step S724), the inspection item identifying unit 104 identifies an inspection pattern candidate having the largest calculated sum of the products to be an inspection pattern (step S725).

Having identified the inspection pattern at step S725, the inspection item identifying unit 104 outputs an identification result (step S716), and ends the inspection item identification processing according to the present embodiment (return).

In this manner, in the inspection item identification processing according to the present embodiment, one inspection pattern is identified from among multiple estimated patterns based on importance degrees and weights registered in the inspection item database 110. In the inspection item identification processing according to the present embodiment, the sum of each product of a watching time and a weight is calculated not only for any inspection item having the highest importance degree but for all inspection items in each estimated pattern, and an estimated pattern having the largest calculated sum is identified to be an inspection pattern. In other words, in the present embodiment, an estimated pattern including the largest number of inspection items having a second highest importance degree is identified to be an inspection pattern from among multiple estimated patterns between which the number of inspection items having the highest importance degree is identical. When inspecting a facility, the inspector is highly likely to inspect (gaze at) an inspection item having a second highest importance degree as well as an inspection item having the highest importance degree. Accordingly, it is highly likely that, among multiple estimated patterns between which the number of inspection items having the highest importance degree is identical, inspection items of an estimated pattern including a larger number of inspection items having a second highest importance degree and the order of the inspection items match with items actually inspected by the inspector and the order thereof, respectively. Thus, through the inspection item identification processing according to the present embodiment, items actually inspected by the inspector and the order thereof can be identified from multiple estimated patterns between which the number of inspection items having the highest importance degree is identical.

In the present embodiment, similarly to the first embodiment, there are the three importance degrees of “requisite”, “important”, and blank in the inspection item database 110. However, the number of importance degrees in the inspection item database 110 is not limited thereto, but may be four or more. Combination of weights in the inspection item database 110 are not limited to the combination illustrated in FIG. 14, but is changeable as appropriate. In addition, although no inspection order is specified in the inspection item database 110C illustrated in FIG. 14, the present embodiment is not limited thereto, but an inspection order may be specified like the inspection item database 110A illustrated in FIG. 2.

In the present embodiment, each item name (inspection item) in the inspection item database is associated with a weight in accordance with the importance degree thereof as described above, and this weight is used in the inspection item identification processing. However, in the inspection item identification processing, in place of association with a fixed weight as described above, for example, the weight of an item name (inspection item) having the highest importance degree of “requisite” may be changed as appropriate by multiplying the weight with a probability p (0≦p≦1). The probability p is set based on, for example, a work state of the inspector and the difficulty of inspection. In this manner, an inspection item actually watched by the inspector can be correctly identified independently from, for example, the skill of the inspector (whether the inspector is a novice or a skilled person) by changing the weight of an inspection item having the highest importance degree through multiplication with the probability p.

### Third Embodiment

A third embodiment describes another example of the inspection item estimation processing performed by the pattern comparing unit 103 in the inspection supporting apparatus 1 illustrated in FIG. 1.

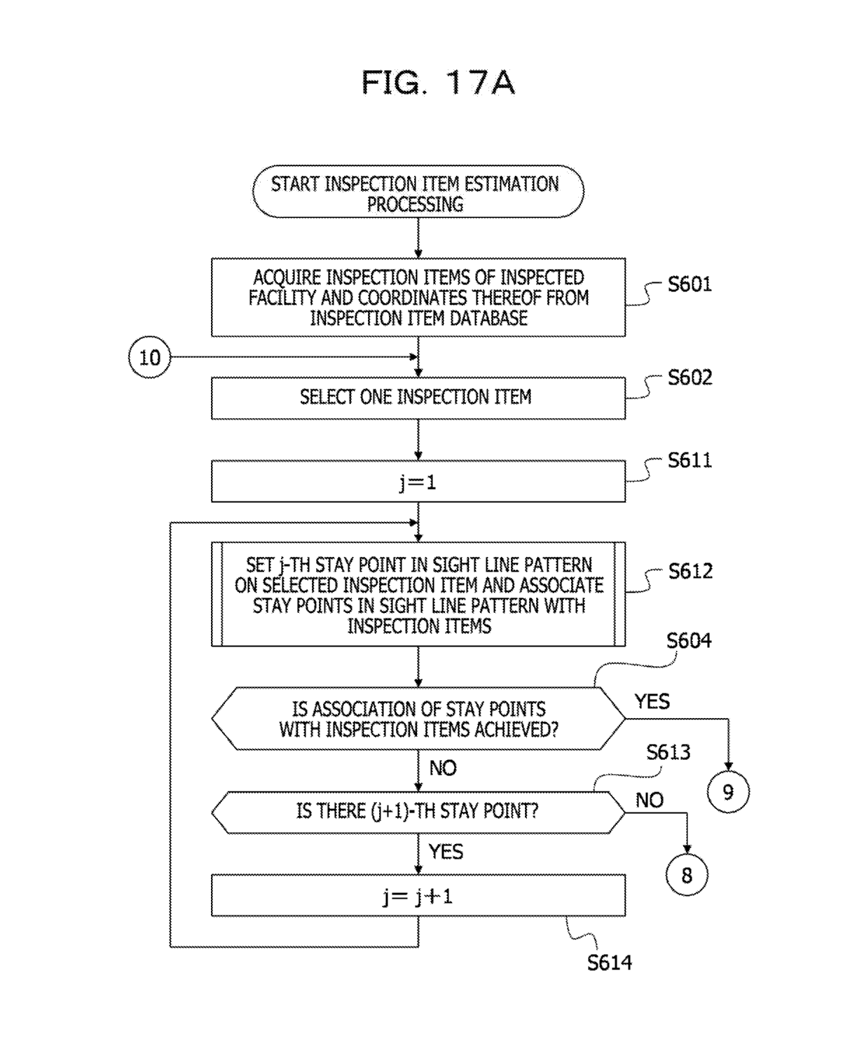

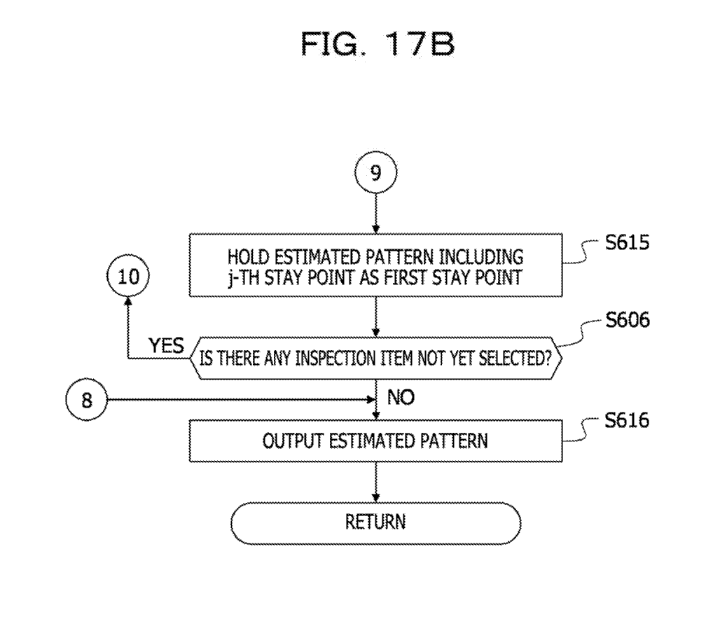

FIG. 17A is a first flowchart for description of the content of the inspection item estimation processing according to the third embodiment. FIG. 17B is a second flowchart for description of the content the inspection item estimation processing according to the third embodiment.

In FIGS. 17A and 17B, any processing same as that in the flowchart illustrated in FIG. 6 is denoted by the same reference sign (step number) in FIG. 6. Detailed description of the processing same as that in the flowchart illustrated in FIG. 6 will be omitted in the following description of the content of the inspection item estimation processing according to the present embodiment with reference to FIGS. 17A and 17B.

When having started the inspection item estimation processing according to the present embodiment, the pattern comparing unit 103 first acquires inspection items of an inspected facility and the coordinates thereof from the inspection item database 110 as illustrated in FIG. 17A (step S601).

Subsequently, the pattern comparing unit 103 selects one of the read inspection items (step S602). At step S602, the pattern comparing unit 103 selects one of the inspection items according to a predetermined selection rule.

Subsequently, the pattern comparing unit 103 sets a variable j to 1, the variable j indicating a sequential number of a stay point in the order in a sight line pattern (step S611).

Subsequently, the pattern comparing unit 103 sets the j-th stay point in the sight line pattern on the selected inspection item over one another to perform the association of a stay point in the sight line pattern and an inspection item with each other (step S612), and determines whether the association of the stay point and the inspection item with each other is achieved (step S604).

At step S612, the pattern comparing unit 103 translates stay points such that, for example, the coordinates of the j-th stay point in the sight line pattern can match with the coordinates of the selected inspection item. Thereafter, the pattern comparing unit 103 determines whether any inspection item is included in a predetermined range around the (j+1)-th stay point or each subsequent stay point, and if any inspection item is included in the predetermined range, associates this inspection item with the stay point. Then, if an inspection item is associated with every stay point at which it is recognized that the inspector has watched an inspection item, the pattern comparing unit 103 determines that the association of the stay point and the inspection item with each other is achieved (YES at step S604). In other words, at step S603 in the flowchart illustrated in FIG. 6, the first stay point (stay point with j=1) is fixedly used as a stay point to be set on the selected inspection item, but at step S612 according to the present embodiment, a stay point inspected second or later can be a target to be set on the inspection item.

If the association of the stay point and the inspection item with each other is achieved (YES at step S604), the pattern comparing unit 103 next holds an estimated pattern including the j-th stay point as the first stay point as illustrated in FIG. 17B (step S615).

After step S615, the pattern comparing unit 103 determines whether there is any inspection item not selected at step S602 (step S606). If there is any inspection item not selected (YES at step S606), the pattern comparing unit 103 repeats the processing at step S602 and later. If all inspection items are selected at step S602 (NO at step S606), the pattern comparing unit 103 outputs the estimated pattern to the inspection item identifying unit 104 (step S607), and ends the inspection item estimation processing (return).

However, if the association of the stay point and the inspection item with each other is not achieved (NO at step S604), the pattern comparing unit 103 next determines whether there is the (j+1)-th stay point (step S613). If there is the (j+1)-th stay point (YES at step S613), the pattern comparing unit 103 updates the variable j with j+1 (step S614), and repeats the processing at step S612 and later. Then, if there is no (j+1)-th stay point (NO at step S613), the pattern comparing unit 103 outputs the estimated pattern to the inspection item identifying unit 104 (step S607) and ends the inspection item estimation processing (return) as illustrated in FIG. 17B.

In this manner, in the inspection item estimation processing according to the present embodiment, if the association of each stay point and an inspection item is achieved while the first stay point of the sight line pattern (stay point with j=1) is set on an inspection item, a result of the association is held as an estimated pattern. If the association of each stay point and an inspection item is not achieved while the first stay point of the sight line pattern is set on an inspection item, a stay point inspected second or later is set on an inspection item to perform the association of each stay point with an inspection item in the inspection item estimation processing according to the present embodiment. Thus, in the inspection item estimation processing according to the present embodiment, for example, if the sight line of the inspector stays at a place different from any inspection item before the inspector starts inspection, any stay point before start of the inspection can be excluded from the association of each stay point with an inspection item.

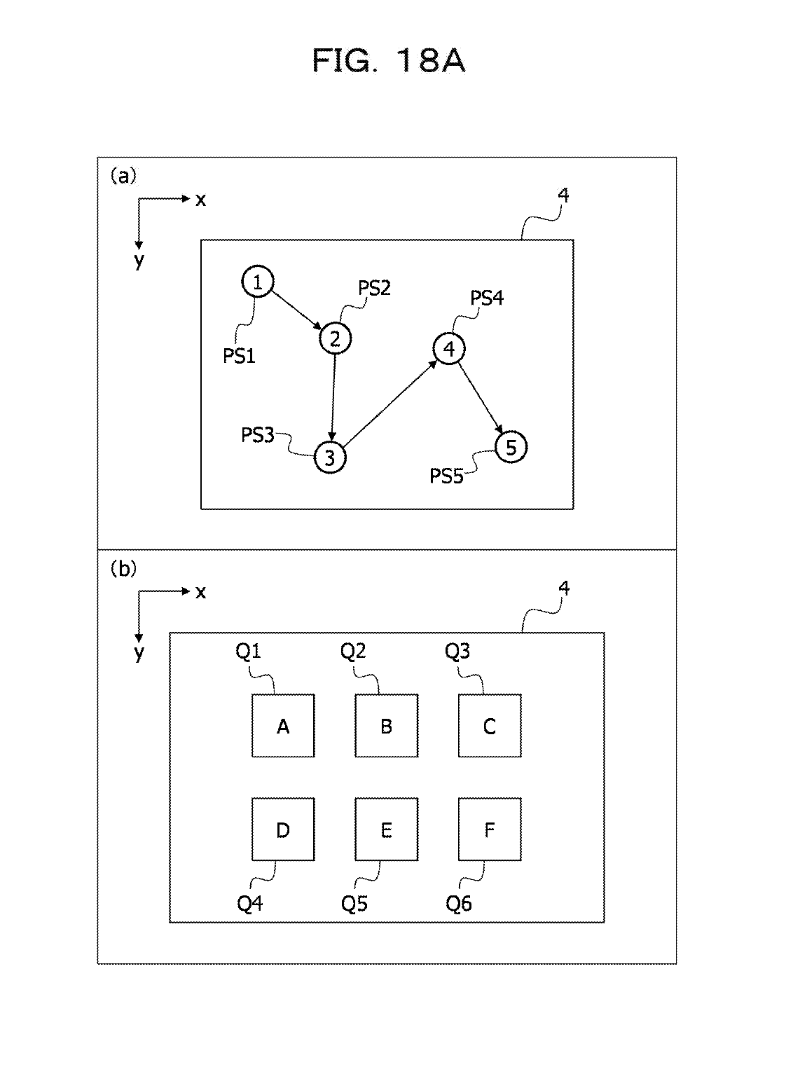

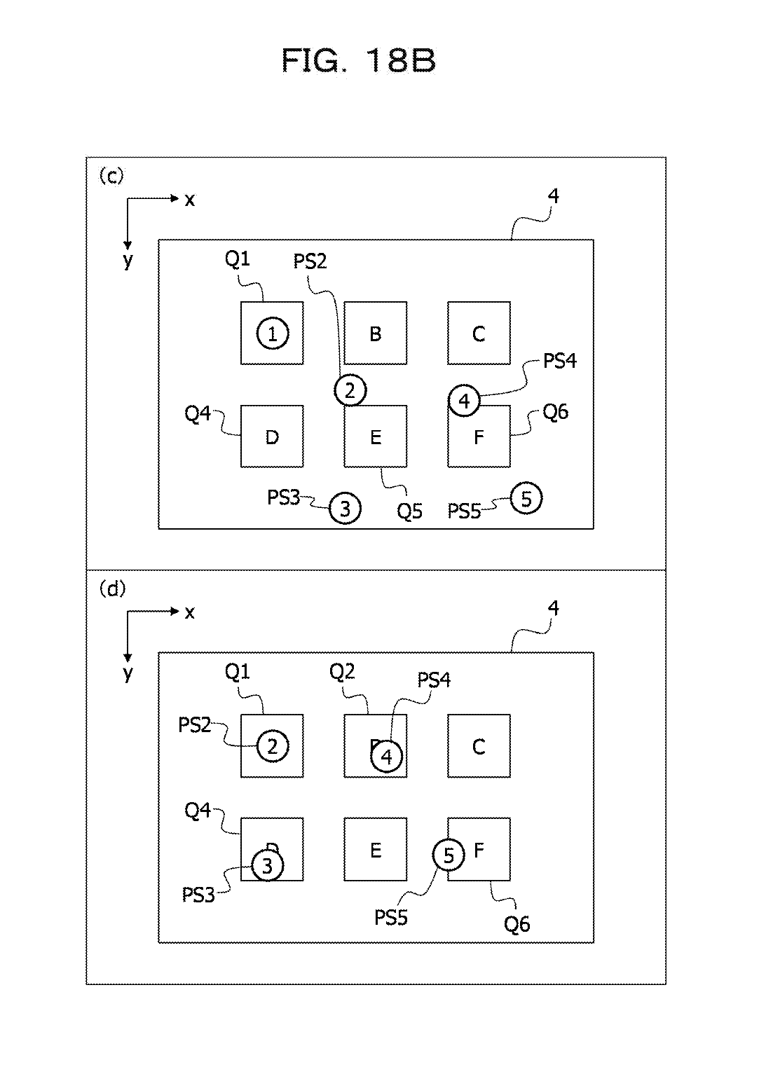

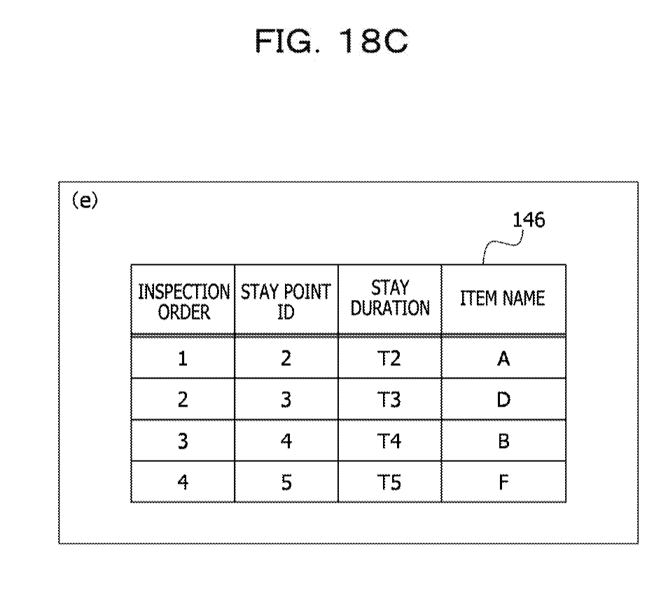

FIG. 18A is a first diagram for description of a fifth example of the association of each stay point with an inspection item. FIG. 18B is a second diagram for description of the fifth example of the association of each stay point with an inspection item. FIG. 18C is a third diagram for description of the fifth example of the association of each stay point with an inspection item.

The diagram (a) of FIG. 18A illustrates a sight line pattern in the plane 4 of the xy coordinate system, in other words, the positions of stay points PS1 to PS5 and the movement sequential number thereof. In the sight line pattern illustrated in (a) of FIG. 18A, the sight line of the inspector stays at the first stay point PS1, which is the first stay point after inspection start, and then moves downward to the right and stays at the second stay point PS2. After staying at the second stay point PS2, the sight line of the inspector moves downward and stays at the third stay point PS3 at a position substantially identical to that of the second stay point PS2 in the horizontal direction (x direction). After staying at the third stay point PS3, the sight line of the inspector moves upward to the right and stays at the fourth stay point PS4 at a position substantially identical to that of the second stay point PS2 in the vertical direction (y direction). After staying at the fourth stay point PS4, the sight line of the inspector moves downward to the right and stays at the fifth stay point PS5 at a position substantially identical to that of the third stay point PS3 in the vertical direction.

The diagram (b) of FIG. 18A illustrates an arrangement pattern of inspection items Q1 to Q6 of an inspected facility in the plane 4 of the xy coordinate system. In the arrangement pattern illustrated in (b) of FIG. 18A, the six inspection items Q1 to Q6 are arranged in a 2×3 matrix. The three inspection items Q1 to Q3 in the top row have item names of item name A, item name B, and item name C in this order from the left. The three inspection items Q4 to Q6 in the bottom row have item names of item name D, item name E, and item name F in this order from the left. In the following description, when distinguished, the inspection items Q1 to Q6 are referred to as the first inspection item Q1 to the sixth inspection item Q6, respectively.

In the inspection item estimation processing according to the present embodiment, one inspection item is selected (step S602), the j-th stay point in the sight line pattern is set on the selected inspection item, and the association of each stay point with an inspection item is performed (step S612). In the processing at step S612, the pattern comparing unit 103 first sets the stay point with j=1, in other words, the first stay point of the sight line pattern PS1 on, for example, the first inspection item Q1 to associate each of the stay points PS1 to PS5 with an inspection item. When the first stay point PS1 is set on the first inspection item Q1 in the plane 4, the stay points PS1 to PS5 and the inspection items Q1 to Q6 have, for example, a positional relation as illustrated in (c) of FIG. 18B. In other words, the second stay point PS2 is positioned near the outer periphery of the fifth inspection item Q5, and the fourth stay point PS4 is positioned near the outer periphery of the sixth inspection item Q6. Accordingly, the second stay point PS2 and the fourth stay point PS4 can be associated with the fifth inspection item Q5 and the sixth inspection item Q6, respectively.

However, the third stay point PS3 and the fifth stay point PS5 are distant from the inspection items Q4, Q5, and Q6. Thus, when the first stay point PS1 is set on the first inspection item Q1, the third stay point PS3 and the fifth stay point PS5 may not be each associated with an inspection item. Similarly, when the first stay point PS1 is set on any of the other inspection items Q2 to Q6, there is a stay point that may not be associated with an inspection item. In other words, when the first stay point (the first stay point PS1) of the sight line pattern is set on each of the inspection items Q1 to Q6, there is a stay point that may not be associated with an inspection item. Thus, in the inspection item estimation processing illustrated in FIG. 6, no estimated pattern is potentially extracted.

However, in the inspection item estimation processing according to the present embodiment, if there is a stay point that may not be associated with an inspection item when the first stay point PS1 is set on each of the inspection items Q1 to Q6, the second stay point PS2 is set on any of the inspection items Q1 to Q6 to perform the association. When the second stay point PS2 in the sight line pattern illustrated in (a) of FIG. 18A is set on the first inspection item Q1, the third stay point PS3 to the fifth stay point PS5 and the inspection items Q1 to Q6 have a positional relation as illustrated in (d) of FIG. 18B.

The third stay point PS3 and the fourth inspection item Q4 overlap with each other. Thus, when the sight line for the second stay point PS2 points to the first inspection item Q1, it is recognized that the sight line for the third stay point PS3 points to the fourth inspection item Q4. The fourth stay point PS4 and the second inspection item Q2 overlap with each other. Thus, when the sight line for the second stay point PS2 points to the first inspection item Q1, it is recognized that the sight line for the fourth stay point PS4 points to the second inspection item Q2.

In addition, the fifth stay point PS5 has a center (barycenter) near the outer periphery of the sixth inspection item Q6. Thus, when the sight line for the second stay point PS2 points to the first inspection item Q1, it is recognized that the sight line for the fifth stay point PS5 points to the sixth inspection item Q6.

In other words, when the second stay point PS2 as the first stay point after inspection start is set on the first inspection item Q1, inspection items are associated with all the stay points at which the inspector is recognized as watching the inspection items PS2 to PS5. Thus, in the determination at step S604 after the processing at step S612 with j=2, the pattern comparing unit 103 determines that the association of each stay point with an inspection item is achieved (YES at step S604). Accordingly, the pattern comparing unit 103 produces and holds an estimated pattern 146 including the second stay point PS2 as the first stay point after inspection start as illustrated in (e) of FIG. 18C (step S615).

In this manner, according to the present embodiment, it is possible to avoid such a situation that no inspection pattern is identified due to an error in the first stay point after inspection start.

### Fourth Embodiment

A fourth embodiment describes another example of the inspection item identification processing performed by the inspection item identifying unit 104 in the inspection supporting apparatus 1 illustrated in FIG. 1.

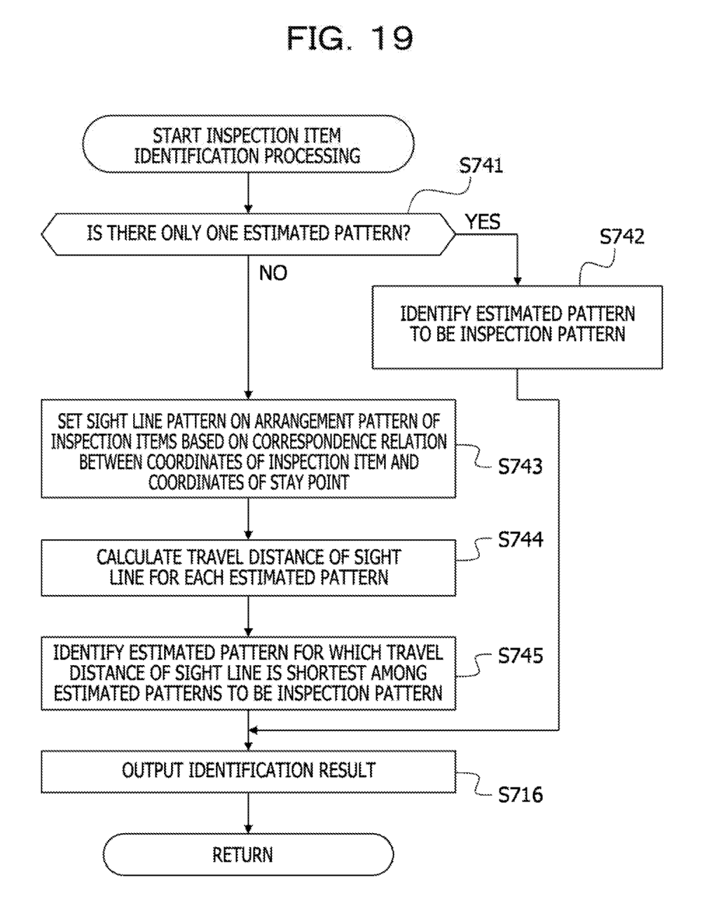

FIG. 19 is a flowchart for description of the content of the inspection item identification processing according to the fourth embodiment.

The inspection item identification processing according to the present embodiment is performed when one or more estimated patterns are extracted in the inspection item estimation processing. When having started the inspection item identification processing, the inspection item identifying unit 104 first determines whether there is only one estimated pattern as illustrated in FIG. 19 (step S741). If there is only one estimated pattern (YES at step S741), the inspection item identifying unit 104 identifies this estimated pattern to be an inspection pattern (step S742). In this case, the inspection item identifying unit 104 outputs the inspection pattern identified at step S742 as an identification result (step S716), and ends the inspection item identification processing (return).

If there are two or more estimated patterns (NO at step S741), the inspection item identifying unit 104 next sets each sight line pattern on an arrangement pattern of inspection items based on a correspondence relation between the coordinates of each inspection item and the coordinates of a stay point (step S743).

Subsequently, the inspection item identifying unit 104 calculates a travel distance of the sight line for each estimated pattern (step S744). At step S744, the inspection item identifying unit 104 calculates, for each estimated pattern, for example, an inter-barycenter distance between a stay point and an inspection item corresponding to the stay point in the estimated pattern, and sets the sum of the distances to be the travel distance of the sight line.

Subsequently, the inspection item identifying unit 104 identifies an estimated pattern for which the travel distance of the sight line is shortest among the estimated patterns to be an inspection pattern (step S745). Having identified the inspection pattern at step S745, the inspection item identifying unit 104 outputs the identified inspection pattern (step S716), and ends the inspection item identification processing (return).

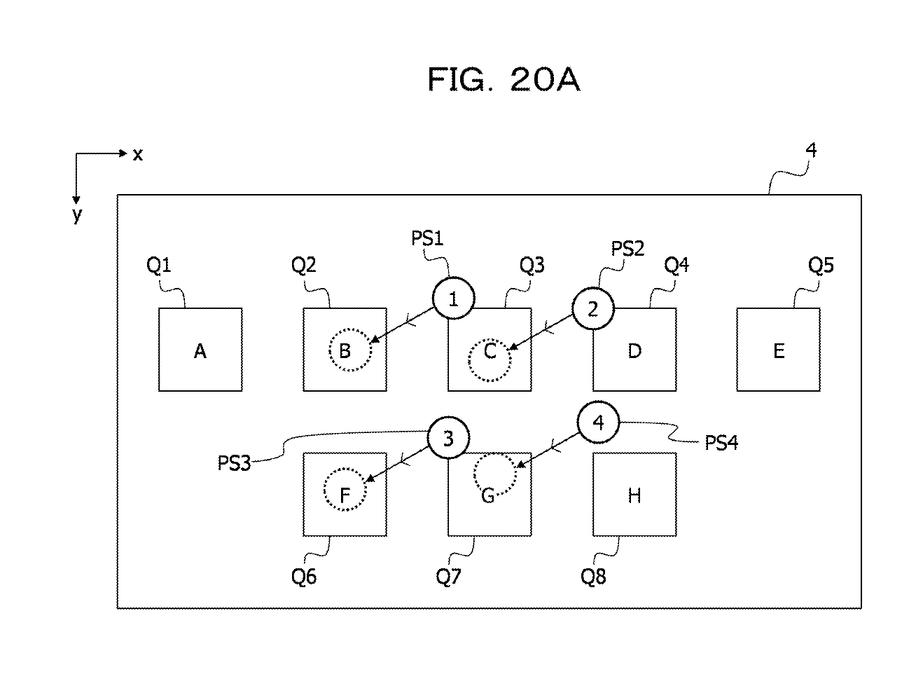

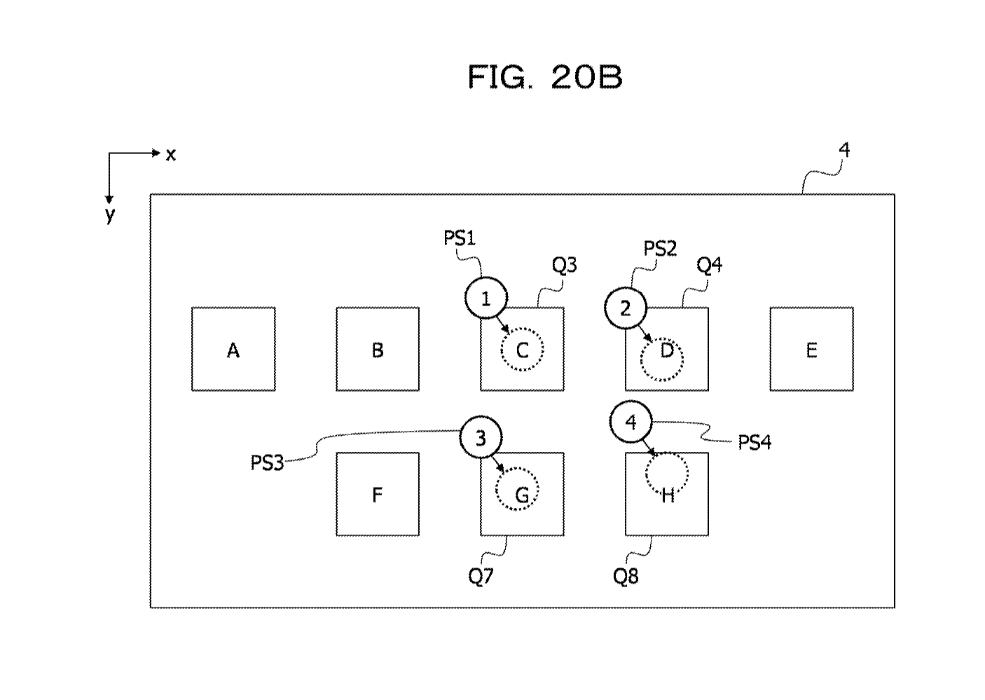

FIG. 20A is a first diagram for description of a sixth example of the association of each stay point with an inspection item. FIG. 20B is a second diagram for description of the sixth example of the association of each stay point with an inspection item.

FIG. 20A illustrates an arrangement pattern of inspection items in the plane 4 of the xy coordinate system and a sight line pattern (the positions of stay points PS1 to PS4 and the movement sequential number thereof).

FIG. 20A indicates eight inspection items Q1 to Q8, and the five inspection items Q1 to Q5 among the eight inspection items are arranged in the horizontal direction (x direction). The remaining three inspection items Q6 to Q8 among the eight inspection items are arranged side by side in the horizontal direction below the above-described five inspection items Q1 to Q5. The three inspection items Q6 to Q8 are arranged at positions identical to the positions of the inspection items Q2 to Q4, respectively, in the x direction.

The five inspection items Q1 to Q5 in the top row have item names of item name A, item name B, item name C, item name D, and item name E in this order from the left. The three inspection items Q6 to Q9 in the bottom row have item names of item name F, item name G, and item name H in this order from the left. In the following description, when distinguished, the eight inspection items Q1 to Q8 are referred to as the first inspection item Q1 to the eighth inspection item Q8, respectively.

The sight line pattern illustrated in FIG. 20A includes the four stay points PS1 to PS4. In the sight line pattern illustrated in FIG. 20A, the sight line of the inspector stays at the first stay point PS1, which is the first stay point after inspection start, and then moves to the right and stays at the second stay point PS2. After staying at the second stay point PS2, the sight line of the inspector moves downward to the left and stays at the third stay point PS3 at a position substantially identical to that of the first stay point PS1 in the horizontal direction (x direction). After staying at the third stay point PS3, the sight line of the inspector moves to the right and stays at the fourth stay point PS4 at a position substantially identical to that of the second stay point PS2 in the horizontal direction. The four stay points PS1 to PS4 in the plane 4 illustrated in FIG. 20A are disposed at positions obtained when the coordinates of the stay points in a first coordinate system calculated based on sight line information detected by the sight line detecting unit 101 are converted into coordinates in a coordinate system of the plane 4 on which the inspection items Q1 to Q8 are disposed. In other words, in the example illustrated in FIG. 20A, it is highly likely that the inspector has inspected the third inspection item Q3, the fourth inspection item Q4, the seventh inspection item Q7, and the eighth inspection item Q8 in this order. However, when the sight line pattern (the four stay points PS1 to PS4) is translated downward to the left so that the first stay point PS1 and the second inspection item Q2 overlap with each other, all four stay points PS1 to PS4 are associated with inspection items. Thus, when the inspection item estimation processing described in, for example, the first embodiment is performed, the pattern comparing unit 103 first extracts a first estimated pattern indicating that inspection is performed the second inspection item Q2, the third inspection item Q3, the sixth inspection item Q6, and the seventh inspection item Q7 in this order.

According to the positional relation between inspection items and stay points of the sight line pattern illustrated in FIG. 20A, as described above, it is highly likely that the inspector has inspected the third inspection item Q3, the fourth inspection item Q4, the seventh inspection item Q7, and the eighth inspection item Q8 in this order. In other words, as illustrated in FIG. 20B, when the sight line pattern (the four stay points PS1 to PS4) is translated downward to the right so that the first stay point PS1 and the third inspection item Q3 overlap with each other, all four stay points PS1 to PS4 are associated with inspection items. Thus, when the inspection item estimation processing described in, for example, the first embodiment is performed, the pattern comparing unit 103 extracts a second estimated pattern indicating that inspection is performed on the third inspection item Q3, the fourth inspection item Q4, the seventh inspection item Q7, and the eighth inspection item Q8 in this order.

When multiple estimated patterns are extracted in the inspection item estimation processing in this manner, in the first to third embodiments, one inspection pattern is identified based on, for example, an inspection order, an importance degree, and a weight of each inspection item, and a duration (stay duration) for which the inspector has watched the inspection item. However, in the present embodiment, as described above, the travel distance of the sight line is calculated for each estimated pattern, and an estimated pattern for which the travel distance is shortest is identified to be an inspection pattern. The travel distance of the sight line in one estimated pattern is obtained by calculating, for each stay point of the sight line pattern, an inter-barycenter distance between the stay point and an inspection item corresponding to the stay point, and calculating the sum of these inter-barycenter distances.

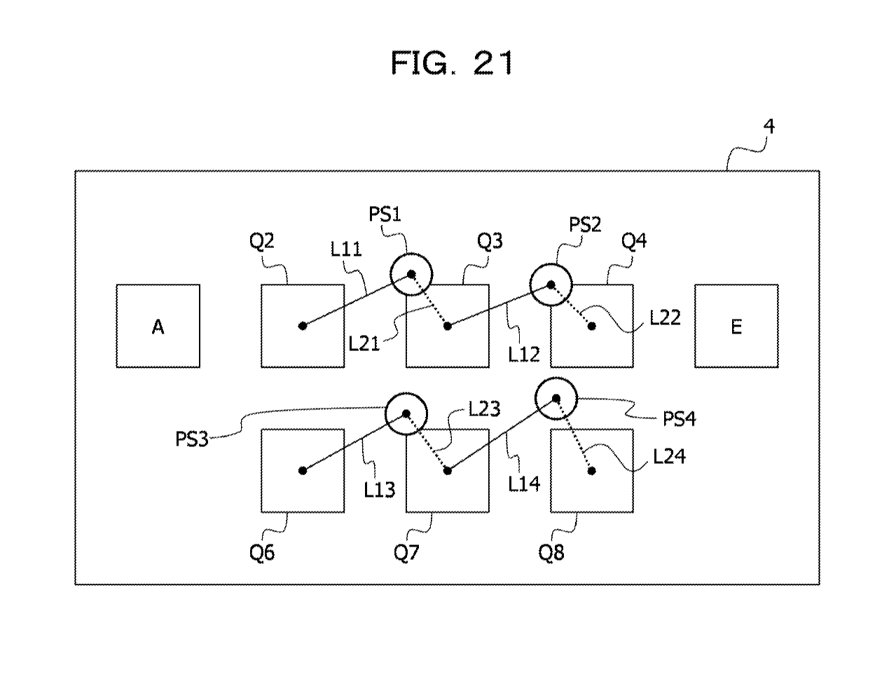

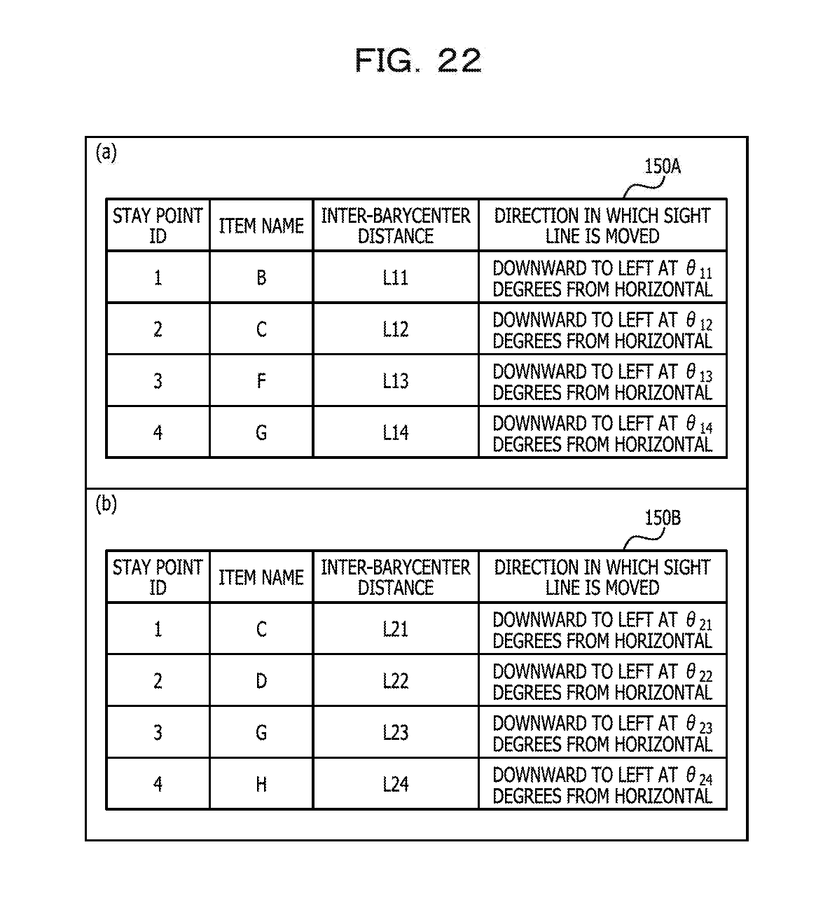

FIG. 21 is a diagram for description of an inter-barycenter distance between a stay point and an inspection item. FIG. 22 is a diagram illustrating an exemplary positional relation between stay points and inspection items.

FIG. 21 illustrates an arrangement pattern of the inspection items Q1 to Q8 in the plane 4 and a sight line pattern (the stay points PS1 to PS4), which are same as those in FIGS. 20A and 20B. In other words, the first estimated pattern (refer to FIG. 20A) the inspection item estimation processing is performed on the patterns illustrated in FIG. 21, the second estimated pattern (refer to FIG. 20B) is extracted. Accordingly, when the inspection item identification processing according to the present embodiment is performed, the inspection item identifying unit 104 calculates the travel distance of the sight line for the first estimated pattern and the travel distance of the sight line for the second estimated pattern.

When calculating the travel distance of the sight line, the inspection item identifying unit 104 produces tables 150A and 150B indicating a positional relation between stay points and inspection items, as illustrated in (a) and (b) of FIG. 22. The table 150A in (a) of FIG. 22 indicates a positional relation between the stay points of the sight line pattern and the inspection items of the first estimated pattern. The table 150B in (b) of FIG. 22 indicates a positional relation between the stay points of the sight line pattern and the inspection items of the second estimated pattern. As described above, the tables 150A and 150B indicating the positional relation among the stay points and the inspection items include an inter-barycenter distance and a direction in which the sight line is moved.

In the first estimated pattern, the first stay point PS1 and the second inspection item Q2 are associated with each other, and the second stay point PS2 the third inspection item Q3 are associated with each other. In the first estimated pattern, the third stay point PS3 and the sixth inspection item Q6 are associated with each other, and the fourth stay point PS4 and the seventh inspection item Q7 are associated with each other. Thus, a travel distance G1 of the sight line for the first estimated pattern is the sum of inter-barycenter distances between the barycenters of the stay points PS1 to PS4 in the sight line pattern and the barycenters of the inspection items Q2, Q3, Q6, and Q7 corresponding to the respective stay points, and is calculated by Expression (2-1) below.

G1=L11+L12+L13+L14 (2-1)

In Expression (2-1), L11 represents an inter-barycenter distance between the barycenter of the first stay point PS1 and the barycenter of the second inspection item Q2, and L12 represents an inter-barycenter distance between the barycenter of the second stay point PS2 and the barycenter of the third inspection item Q3. In Expression (2-1), L13 represents an inter-barycenter distance between the barycenter of the third stay point PS3 and the barycenter of the sixth inspection item Q6, and L14 represents an inter-barycenter distance between the barycenter of the fourth stay point PS4 and the barycenter of the seventh inspection item Q7.

In the second estimated pattern, the first stay point PS1 and the third inspection item Q3 are associated with each other, and the second stay point PS2 and the fourth inspection item Q4 are associated with each other. In the second estimated pattern, the third stay point PS3 and the seventh inspection item Q7 are associated with each other, and the fourth stay point PS4 and the eighth inspection item Q8 are associated with each other. Thus, a travel distance G2 of the sight line for the second estimated pattern is the sum of inter-barycenter distances between the barycenters of the stay points PS1 to PS4 in the sight line pattern and the barycenters of the inspection items Q3, Q4, Q7, and Q8 corresponding to the respective stay points, and is calculated by Expression (2-2) below.

G2=L21+L22+L23+L24 (2-2)

In Expression (2-2), L21 represents an inter-barycenter distance between the barycenter of the first stay point PS1 and the barycenter of the third inspection item Q3, and L22 represents an inter-barycenter distance between the barycenter of the second stay point PS2 and the barycenter of the fourth inspection item Q4. In Expression (2-2), L23 represents an inter-barycenter distance between the barycenter of the third stay point PS3 and the barycenter of the seventh inspection item Q7, and L24 represents an inter-barycenter distance between the barycenter of the fourth stay point PS4 and the barycenter of the eighth inspection item Q8.

Having calculated the travel distance G1 of the sight line for the first estimated pattern and the travel distance G2 of the sight line for the second estimated pattern in this manner, the inspection item identifying unit 104 identifies an estimated pattern having a smaller travel distance to be an inspection pattern. In other words, when the relation of G1<G2 holds, the inspection item identifying unit 104 identifies the first estimated pattern to be an inspection pattern. When the relation of G1>G2 holds, the inspection item identifying unit 104 identifies the second estimated pattern to be an inspection pattern. Since the relation of G1>G2 holds in the example illustrated in FIG. 21, the inspection item identifying unit 104 identifies the second estimated pattern to be an inspection pattern. In other words, the inspection supporting apparatus 1 (the inspection item identifying unit 104) identifies that the inspector has inspected the third inspection item Q3, the fourth inspection item Q4, the seventh inspection item Q7, and the eighth inspection item Q8 in this order.

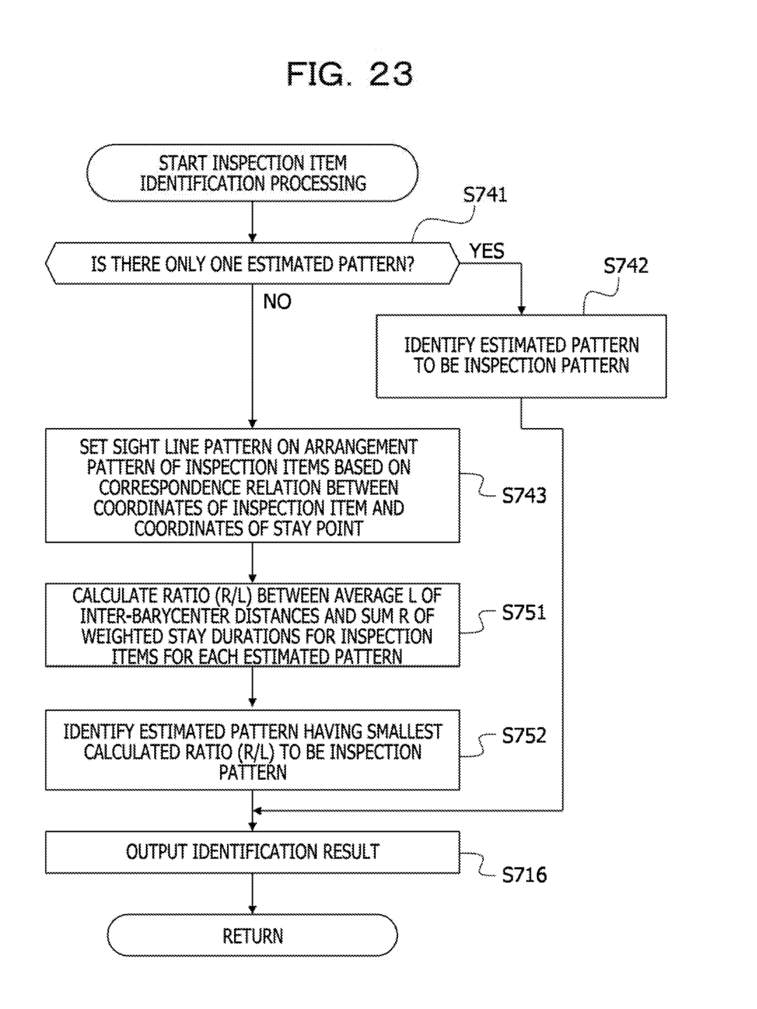

FIG. 23 is a flowchart for description of a modification of the inspection item identification processing according to the fourth embodiment.

The inspection supporting apparatus 1, which performs the inspection item identification processing according to the present embodiment, can use the inspection item database 110 that adds, to each item name (inspection item), information on a weight in accordance with the importance degree thereof, like the inspection item database 110C illustrated in FIG. 14. When a weight for each inspection item is set in the inspection item database 110C in this manner, the inspection item identification processing performed by the inspection item identifying unit 104 may be processing as illustrated in, for example, FIG. 23. In a flowchart illustrated in FIG. 23, the processing at steps S744 and S745 in the flowchart illustrated in FIG. 19 is replaced with processing described below.

In place of the processing at step S744 in FIG. 19, processing (step S751) of calculating a ratio (R/L) between an average L of inter-barycenter distances and a sum R of weighted stay durations for the inspection items is performed for each estimated pattern in the flowchart illustrated in FIG. 23. At step S751, the inspection item identifying unit 104 first calculates the average L of inter-barycenter distances and the sum R of weighted stay durations for the inspection items. The average L of inter-barycenter distances is, for example, an average value of the inter-barycenter distances L11 to L14 illustrated in FIG. 21. The sum R of weighted stay durations for the inspection items is a sum of each product of a stay duration (duration for which the inspector has watched an inspection item) calculated for each inspection item and a weight as expressed in, for example, Expression (1-1).

In place of the processing at step S745 in FIG. 19, processing (step S752) of identifying an estimated pattern for which the calculated ratio (R/L) is lowest to be an inspection pattern is performed in the flowchart illustrated in FIG. 23.

The flowcharts in FIGS. 19 and 23 are merely examples of the inspection item identification processing according to the fourth embodiment. The inspection item identification processing according to the present embodiment may be, for example, processing in which the processing of the flowchart illustrated in FIG. 19 or 23 is incorporated in the inspection item identification processing described in the first to third embodiments. In other words, the processing illustrated in FIG. 19 or 23 may be performed as one processing of identifying one inspection pattern from among multiple estimated patterns based on, for example, an importance degree, an inspection order, and a weight that are associated with an item name (inspection item) in the inspection item database 110, and a stay duration of an estimated pattern.

The above-described embodiments exemplarily describe the inspection supporting apparatus 1 configured to set an inspection item (inspection point) of a facility to be an object to which the sight line of a person points and support an inspection operation by identifying any item inspected by the person (inspector) and the order of the inspection. However, an object to which the sight line of a person points is not limited to an inspection item of a facility, but may be any optional object. Specifically, the inspection supporting apparatus 1 is applicable, as a sight line identification apparatus, to any usage other than support of an inspection operation of a facility by replacing an item name (inspection item) registered in the inspection item database 110 with information on another object. The sight line identification apparatus achieved based on the above-described embodiments is capable of identifying to which object the sight line of a person has pointed in which order irrespective of the kind of the object.

In the above-described embodiments, when multiple inspection patterns are estimated based on the inspection item database 110 and a sight line pattern produced based on information acquired from the sight line sensor 2, one of the estimated patterns is identified. However, the processing performed by the inspection supporting apparatus 1 (sight line identification apparatus) according to the above-described embodiments can be understood as follows. First, the inspection supporting apparatus 1 identifies the direction of a sight line based on information acquired from the sight line sensor. Subsequently, the inspection supporting apparatus 1 estimates an object positioned in the identified direction of the sight line by referring to an arrangement relation (the inspection item database 110, for example) between multiple objects. Thereafter, the inspection supporting apparatus 1 corrects the identified direction of the sight line based on a transition order of the estimated objects and data which is stored in the storage apparatus and indicates an order of objects to be pointed to by a sight line. When the processing performed by the inspection supporting apparatus 1 is understood as correction of the identified direction of the sight line as described above, the sight line pattern producing unit 102 in the inspection supporting apparatus 1 is an identifying unit configured to perform the processing of identifying the direction of the sight line. The pattern comparing unit 103 in the inspection supporting apparatus 1 is an estimating unit configured to perform the processing of estimating an object positioned in the identified direction of the sight line by referring to an arrangement relation (the inspection item database 110) between multiple objects stored in the storage unit. The inspection item identifying unit 104 in the inspection supporting apparatus 1 is a correcting unit configured to correct the identified direction of the sight line based on a transition order of the estimated objects and data on an order of the objects pointed to by the sight line (the inspection item database 110) stored in the storage unit.

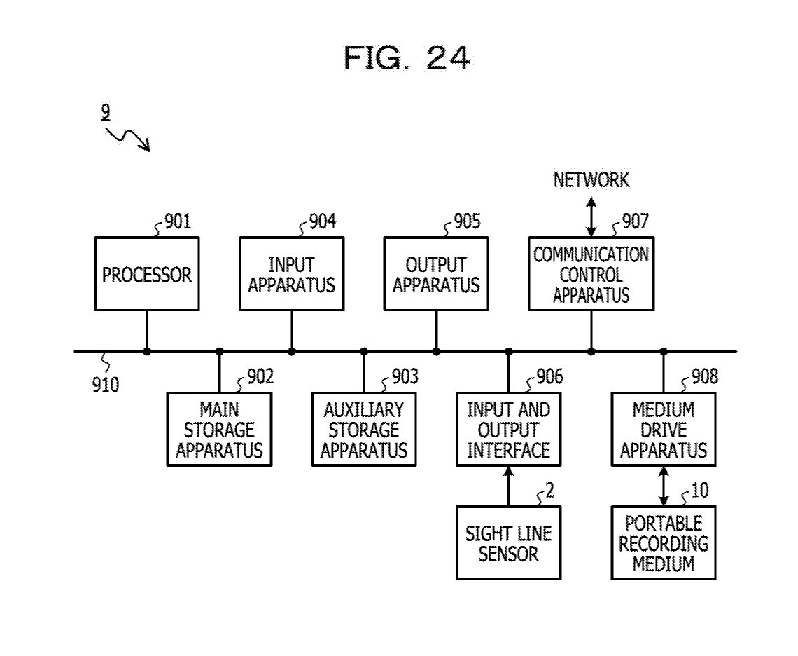

The inspection supporting apparatus 1 according to the above-described embodiments may be achieved by using, for example, a computer and a computer program executed by this computer. The following describes the inspection supporting apparatus 1 achieved by using the computer and the computer program with reference to FIG. 24.

FIG. 24 is a diagram illustrating a hardware configuration of the computer.

As illustrated in FIG. 24, this computer 9 includes a processor 901, a main storage apparatus 902, an auxiliary storage apparatus 903, an input apparatus 904, an output apparatus 905, an input and output interface 906, a communication control apparatus 907, and a medium drive apparatus 908. These components 901 to 908 of the computer 9 are connected with each other through a bus 910 to enable transfer of data between the components.

The processor 901 is, for example, a central processing unit (CPU) or a micro processing unit (MPU). The processor 901 controls the entire operation of the computer 9 by executing various computer programs including an operating system. The processor 901 performs various kinds of arithmetic processing including arithmetic processing in, for example, the sight line pattern producing processing (refer to FIG. 3), the inspection item estimation processing (refer to FIGS. 6, 7A, and 7B, for example), and the inspection item identification processing (refer to FIGS. 12A to 12C, for example).

The main storage apparatus 902 includes a read only memory (ROM) and a random access memory (RAM) (not illustrated). The ROM of the main storage apparatus 902 stores in advance, for example, a predetermined basic control program read by the processor 901 at activation of the computer 9. The RAM of the main storage apparatus 902 is used as a work storage region by the processor 901 executing various computer programs as desired. The RAM of the main storage apparatus 902 may be used to temporarily store, for example, the inspection item database 110, an image acquired from the sight line sensor, an estimated pattern, and an identified inspection pattern.

The auxiliary storage apparatus 903 is, for example, a non-transitory memory (including a solid state drive (SSD)) such as a flash memory or a hard disk drive (HDD). The auxiliary storage apparatus 903 may store therein various computer programs executed by the processor 901 and various kinds of data. The auxiliary storage apparatus 903 may be used to store, for example, computer programs including the sight line pattern producing processing, the inspection item estimation processing, and the inspection item identification processing. The auxiliary storage apparatus 903 may be used to store, for example, the inspection item database 110, an image acquired from the sight line sensor, an estimated pattern, and an identified inspection pattern.

The input apparatus 904 is, for example, a keyboard apparatus or a touch panel apparatus. When an operator (user) of the computer 9 performs a predetermined operation on the input apparatus 904, the input apparatus 904 transmits input information associated with the content of the operation to the processor 901.

The output apparatus 905 includes, for example, a display apparatus such as a liquid crystal display apparatus. The output apparatus 905 may be used to display, for example, an operation state of the computer 9 and a result of the inspection item identification processing.

The input and output interface 906 connects the computer 9 with another electronic apparatus. The input and output interface 906 includes, for example, a connector of a universal serial bus (USB) standard. Examples of electronic apparatuses connectable with the computer 9 through the input and output interface 906 include the sight line sensor 2.

The communication control apparatus 907 is an apparatus configured to connect the computer 9 to a communication network and control various kinds of communication between the computer 9 and another electronic apparatus through the communication network. The communication control apparatus 907 may be used to transmit, for example, an identified inspection pattern and other inspection results to a predetermined management server after inspection. This transmission of, for example, an identified inspection pattern to the management server by the computer 9 (inspection supporting apparatus 1) allows central management of inspection results for inspectors by multiple computers 9.

The medium drive apparatus 908 performs reading of a computer program and data recorded in a portable recording medium 10, and writing, for example, data stored in the auxiliary storage apparatus 903 to the portable recording medium 10. The medium drive apparatus 908 may be, for example, a memory-card reader/writer supporting one or multiple kinds of standards. When the memory-card reader/writer is used as the medium drive apparatus 908, the portable recording medium 10 may be, for example, a memory card (flash memory) of a secure digital (SD) standard as one of the standards supported by the memory-card reader/writer. The portable recording medium 10 may be also, for example, a flash memory including a connector of the USB standard. The portable recording medium 10 may be used to store, for example, a computer program configured to identify an inspection item, an image acquired from the sight line sensor 2, and an inspection item database.

When the computer 9 includes an optical disk drive usable as the medium drive apparatus 908, various optical disks readable by this optical disk drive may be used as the portable recording medium 10. Examples of optical disks usable as the portable recording medium 10 include a compact disc (CD), a digital versatile disc (DVD), and a Blu-ray (registered trademark) disc.

When the inspector inputs a command to start the computer program configured to identify an inspection item through, for example, the input apparatus 904, the processor 901 of the computer 9 reads the computer program from, for example, the auxiliary storage apparatus 903 and executes the computer program. In this case, the processor 901 functions (operates) as the sight line detecting unit 101, the sight line pattern producing unit 102, the pattern comparing unit 103, the inspection item identifying unit 104, and the output unit 105 of the inspection supporting apparatus 1. For example, the RAM of the main storage apparatus 902 and the auxiliary storage apparatus 903 function as the storage unit storing therein the inspection item database 110, the sight line information accumulating unit 120, and the identification result accumulating unit 121.

The computer 9, which is operated as the inspection supporting apparatus 1, may not include all components 901 to 908 illustrated in FIG. 24, but part of the components may be omitted in accordance with a usage and a condition. For example, the communication control apparatus 907 and the medium drive apparatus 908 may be omitted from the computer 9.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A sight line identification apparatus comprising:
a sight line sensor configured to output a signal in accordance with a sight line;
a memory configured to store positional information between a plurality of objects; and
a processor coupled to the memory and configured to:
produce a sight line pattern including a position of the sight line or a direction of the sight line based on the output signal from the sight line sensor,
estimate each objects pointed to by the sight line and an order of the objects pointed to by the sight line, based on information including the positional information and the sight line pattern, and
when there are a plurality of combinations of the estimated objects and the estimated order of the objects, select one of the plurality of combinations based on the positional information.

2. The sight line identification apparatus according to the claim 1, the processor further configured to:
produce a sight line pattern including a direction of the sight line at a stay in a predetermined range for a predetermined duration, and an order of the directions of the sight line at the stay, and
use one of the directions of the sight line at the stay, as a direction of the sight line pointing to one of the objects, associate the other directions of the sight line in the sight line pattern with the objects.

3. The sight line identification apparatus according to the claim 1, the processor further configured to:
associate the directions of the sight line with the objects with the direction of the sight line at first stay in the sight line pattern matching with the direction of any of the objects.

4. The sight line identification apparatus according to the claim 1, the processor further configured to:
associate the directions of the sight line with the objects with the direction of the sight line at first stay in the sight line pattern matching with the direction of any of the objects, and
when the directions of the sight line at stays include a direction of the sight line pointing to none of the objects and a difference between the direction of the sight line pointing to none of the objects and the direction of the sight line pointing to any of the objects is equal to or larger than a threshold, exclude the direction of the sight line pointing to none of the objects from the sight line pattern, and estimate the object pointed to by the sight line and the order of the object pointed to by the sight line.

5. The sight line identification apparatus according to the claim 1, wherein
the arrangement information of the objects stored in the memory includes information indicating an order of some or all of the objects pointed to by the sight line,
the processor further configured to identify, among the combinations, a combination for which the order of the objects pointed to by the sight line, which is identified based on the order of the directions of the sight line at stays, matches with the order in information which is stored in the memory and which includes the order of the objects pointed to by the sight line.

6. The sight line identification apparatus according to the claim 1, wherein
the arrangement information of the objects stored in the memory includes information indicating importance degrees of the objects,
the processor further configured to identify, in the processing of identifying one of the combinations, a combination that includes the largest number of the objects having high importance degrees among the combinations.

7. The sight line identification apparatus according to the claim 1, wherein
the arrangement information of the objects stored in the memory includes information indicating importance degrees of the objects,
the processor further configured to identify a combination in which a sum of stay durations of the direction of the sight line associated with the object having the highest importance degree is largest among the combinations.

8. The sight line identification apparatus according to the claim 1, wherein
the arrangement information of the objects stored in the memory includes weighting values in accordance with importance degrees of the objects,
the processor further configured to calculate, for each of the combinations, a product of a stay duration for a direction of the sight line associated with each of the objects and the weighting value of the object, calculate a sum of the calculated products of the stay durations and the weighting values for each of the combinations, and identify the combination for which the calculated sum is largest among the combinations.

9. The sight line identification apparatus according to the claim 1, wherein
the objects are inspection items of a facility, and
the arrangement information of the objects stored in the memory includes weighting values in accordance with importance degrees of the objects,
the processor further configured to determine a probability value that changes the weighting values in a probabilistic manner depending on a skill of an inspector which takes charge of inspection of the facility, calculate, for each of the combinations, a product of a stay duration for a direction of the sight line associated with each of the objects, the weighting value of the object, and the probability value, calculate a sum of the calculated products of the stay durations, the weighting values, and the probability values for each of the combinations, and identify the combination for which the calculated sum is largest among the combinations.

10. A sight line identification method for a sight line identification apparatus comprising:
producing, by a processor, a sight line pattern including a position of a sight line or a direction of the sight line based on an output signal from a sight line sensor,
estimating, by the processor, each objects pointed to by the sight line and an order of the objects pointed to by the sight line, based on information including the positional information and the sight line pattern, and
when there are a plurality of combinations of the estimated objects and the estimated order of the objects, selecting, by the processor, one of the plurality of combinations based on the positional information.
